(19) United States
(12) Patent Application Publication
(10) Pub. No.: US 2008/0176182 A1
(43) Pub. Date: Jul. 24, 2008

(54) System and method for electronically modeling jaw articulation

(76) Inventors: Bruce Willard Hultgren, Victoria, MN (US); Michael C. Marshall, Prior Lake, MN (US)

Correspondence Address: MERCHANT & GOULD PC, P.O. BOX 2903, MINNEAPOLIS, MN, 55402-0903, US

(21) Appl. No.: 11/973,280

(22) Filed: Oct. 5, 2007

Related U.S. Application Data
(60) Provisional application No. 60/849,513, filed on Oct. 5, 2006.

(51) Int. Cl. A61C 7/00; A61C 11/00

(52) U.S. Cl. 433/69; 433/73

(57) ABSTRACT

A system and method for determining condyle displacement during jaw articulation includes a physical model with corresponding reference points. The physical model is positioned and scanned to obtain positional data representing a first and second bite position. This positional data is used to generate a transformation matrix. The position of at least one condyle is determined in reference to positional data scanned from the physical model. The transformation matrix is used to map the position of the condyle with respect to the second bite position.

### CROSS REFERENCE TO RELATED APPLICATIONS

This application claims the benefit of U.S. Provisional Application No. 60/849,513, filed Oct. 5, 2006. Such provisional application is incorporated herein by reference.

### TECHNICAL FIELD

This application relates in general to methods and systems for electronically modeling jaw articulation, and more particularly to methods and systems for electronically modeling jaw articulation using a three-dimensional digitizer.

### BACKGROUND

The use of computer-aided manipulating of electronic models that correspond to physical models has become more prevalent as the capabilities of computer processing systems have increased. One such application of this electronic modeling technology is in the dental field in which electronic models are generated that correspond to physical models made from impressions of teeth and gums in a human mouth. Dentists and other dental health professionals have used these physical models for a patient's teeth to study the interaction of the opposing jaws of the patient. In particular, the models may be used before, during, and after a treatment plan is implemented.

One application of this electronic modeling technology is in measuring the shift in position of a patient's left and right mandibular condyles caused by movement of the mandible. The mandibular condyles are the rounded prominences at the end of the mandible used for articulation with the maxilla. For convenience, each condyle may be thought of as defining a point of rotation for the mandible and maxilla. However, the mandible and maxilla do not interact in a strictly hinge-like fashion, rotating about a fixed point. Rather, during jaw articulation, in which the mandible moves with respect to the maxilla, each condyle shifts with respect to its original position and/or the other condyle. Taking this shift in position into account when creating a treatment plan enables the professional to tailor the plan to better suit the actual physical structure and characteristics of the patient.

FIGS. 1a-1b and 2a-2d illustrate various examples of condyle displacement during jaw articulation. Throughout these figures, the labels CR and CL refer to the right and left condyle respectively. The subscript “O” indicates an open mouth position, whereas the subscript “C” indicates a closed mouth position. As these figures show, the positions of each condyle CR, CL can change during jaw articulation. Referring now to FIGS. 1a-1b, one example of condyle displacement during jaw articulation is shown. FIG. 1a illustrates a front view of a patient's jaw in an open mouth position, depicting the left and right condyle positions CR_{O}, CL_{O}. A straight line between the two condyles CR, CL is shown to better illustrate the movement of each condyle in relation to the other. FIG. 1b illustrates a front view of a patient's jaw in a closed mouth position, depicting the left and right condyle positions CR_{C}, CL_{C}. In FIG. 1b, both condyles CR, CL have shifted slightly from their corresponding open mouth positions CR_{O}, CL_{O}.

FIGS. 2a-2d depict other possible examples of condyle displacement during jaw articulation. FIG. 2a depicts a first example E1 in which no displacement occurs during jaw articulation. FIG. 2b depicts another example E2 in which a lateral shift occurs for both condyles CR, CL during jaw articulation. FIG. 2c depicts yet another example E3 in which the left condyle CL shifts drastically with respect to the right condyle CR while the right condyle CR does not shift. FIG. 2d depicts yet another example E4 in which the left condyle CL shifts less drastically in one direction and the right condyle CR shifts less drastically in the opposite direction. However, while neither condyle CR, CL shifts very far between open and closed mouth positions, the resulting total condyle shift between the right condyle CR and the left condyle CL is just as drastic as in FIG. 2c.

One known method to measure condyle displacement for an individual patient includes a dental or orthodontic professional estimating the movement of each condyle based on a tactile observation of the shift. Another known method includes using a face bow to measure the distance between a condyle and a point on the patient's face while the patient holds her jaw in various positions. As will be appreciated, such methods are prone to error of a user in judging the magnitude or direction of the displacement.

Therefore, there arises a need in the art for a more accurate method, apparatus, and system to measure condyle displacement (i.e., or movement) for a patient.

### SUMMARY OF THE INVENTION

This application relates in general to a method and system for determining mandibular condyle displacement during jaw articulation for a patient. The invention enables a user to measure the magnitude and direction of a shift in a patient's left and/or right mandibular condyle caused by movement of the patient's mandible in relation to the maxilla during jaw articulation. The following embodiments are constructed in accordance with the principles of the invention, but do not constitute the invention itself. Rather, the invention is defined in the claims attached hereto.

The method generally includes determining a transformation matrix from a first and second set of positional data, determining a location of a point corresponding to the condyle in relation to the first set of positional data, and transforming the point to the location of the condyle in relation to the second set of positional data using the transformation matrix. The first and second sets of positional data represent the patient's mandible, maxilla, or both in a first and second bite position, respectively.

According to one embodiment, creating a transformation matrix includes determining the location of at least three points in relation to either the mandible or the maxilla when the mandible and maxilla are interacting according to a first bite position. Creating the matrix further includes determining the location of the same three or more points when the mandible and maxilla are interacting according to a second bite position. The transformation matrix is generated based on the positional data of the three points taken in both bite positions.

According to another embodiment, positional data for intermediate positions of the mandible and maxilla between the two bite records may be interpolated, thereby showing jaw articulation in more detail. Position points for the condyle may also be shown for each of these intermediate positions.

According to yet another embodiment, a first and second electronic model is generated based on the positional data sets representing the mandible and maxilla, respectively. The determined and transformed condyle position points are displayed in relation to the electronic model.

According to still yet another possible embodiment, determining the positional data sets includes scanning a physical model including a base, at least a portion of a dental arch on one side of the base, and at least three reference sites on an opposite side of the base.

One aspect of the present invention includes generating an electronic model including the electronic model representing the mandible and the electronic model representing the maxilla on a common coordinate system.

Another aspect of the present invention includes determining a position of the condyle based on medical images. In some embodiments, a user determines the condyle point based on a visual interpretation of the medical image. In other embodiments, a software program determines the condyle point.

While the invention will be described with respect to preferred embodiment configurations and with respect to particular structures used therein, it will be understood that the invention is not to be construed as limited in any manner by either such configurations or structures described herein. Further, it will be appreciated that the present invention need not include each and every one of the features described herein. Instead, methods and assemblies constructed in accordance with the principles of the present invention may utilize one or more of the identified features.

### BRIEF DESCRIPTION OF THE DRAWINGS

FIGS. 1a-1b illustrate one example of condyle displacement during jaw articulation;

FIGS. 2a-2d illustrate various other examples of condyle displacement during jaw articulation;

FIG. 3 illustrates one example embodiment of a composite electronic model including a first and a second electronic model;

FIGS. 4A-4D illustrate the generation of electronic models from scanned data points of physical models;

FIG. 5 illustrates one embodiment of a scanning assembly including a tooling plate structure mounted to a base plate structure;

FIG. 6 illustrates a first side of a physical model configured to not require a tooling plate structure;

FIG. 7 illustrates an opposite side of the physical model shown in FIG. 6;

FIG. 8 illustrates an exploded view of an example scanning assembly;

FIG. 9 illustrates a perspective view of one example embodiment of a scanning assembly including a first and second assembly;

FIG. 10a illustrates a schematic of the electronic model representing the maxilla defined within the coordinate system O;

FIG. 10b illustrates the transformed electronic model representing the maxilla displayed with the electronic model representing the mandible within the coordinate system T;

FIG. 11 illustrates a flow chart depicting the steps used to transform the point P_{O} on the electronic model to the point P_{T} on the transformed electronic model;

FIG. 12 illustrates an example operation flow for a process for generating a condyle transformation matrix M_{C};

FIG. 13 illustrates an example method of measuring the vertical and AP shift of a condyle;

FIG. 14 illustrates an example method of measuring the horizontal shift in condyle position.

FIG. 15 illustrates one example method of determining the location of the patient's condyle;

FIG. 16 illustrates using a digital copy of an X-ray to visually determine the y-axis and z-axis values for the position of the condyle;

FIG. 17 illustrates one possible embodiment of a computing system for generating, manipulating, and storing the various electronic models and/or positional data;

FIG. 18 illustrates a flowchart depicting one example process of digitizing points on a patient's anatomy relative to an electronic model;

FIG. 19 illustrates a flowchart depicting one example process of aligning an electronic model representing a patient's maxilla with an electronic model representing a patient's mandible within the same coordinate system;

FIG. 20 illustrates a flowchart depicting another example process of aligning an electronic model representing a patient's maxilla with an electronic model representing a patient's mandible within the same coordinate system;

FIG. 21 illustrates a digitizing system including a digitizing device and a computing device;

FIG. 22 illustrates a block diagram of one example embodiment of the digitizing system of FIG. 21;

FIG. 23 illustrates one example embodiment of the digitizing device of FIG. 21;

FIG. 24 illustrates one example stylus configured to couple to the digitizing device of FIG. 21;

FIG. 25 illustrates another example stylus configured for use with the digitizing device of FIG. 21;

FIG. 26 illustrates a flowchart depicting one example tracking process for tracking movement of a patient's jaw during jaw articulation and simulating the movement with electronic models; and

FIG. 27 illustrates a flowchart depicting one example tracking process for tracking movement of a feature not represented on the electronic models of FIG. 26, but whose position is known relative to the electronic models.

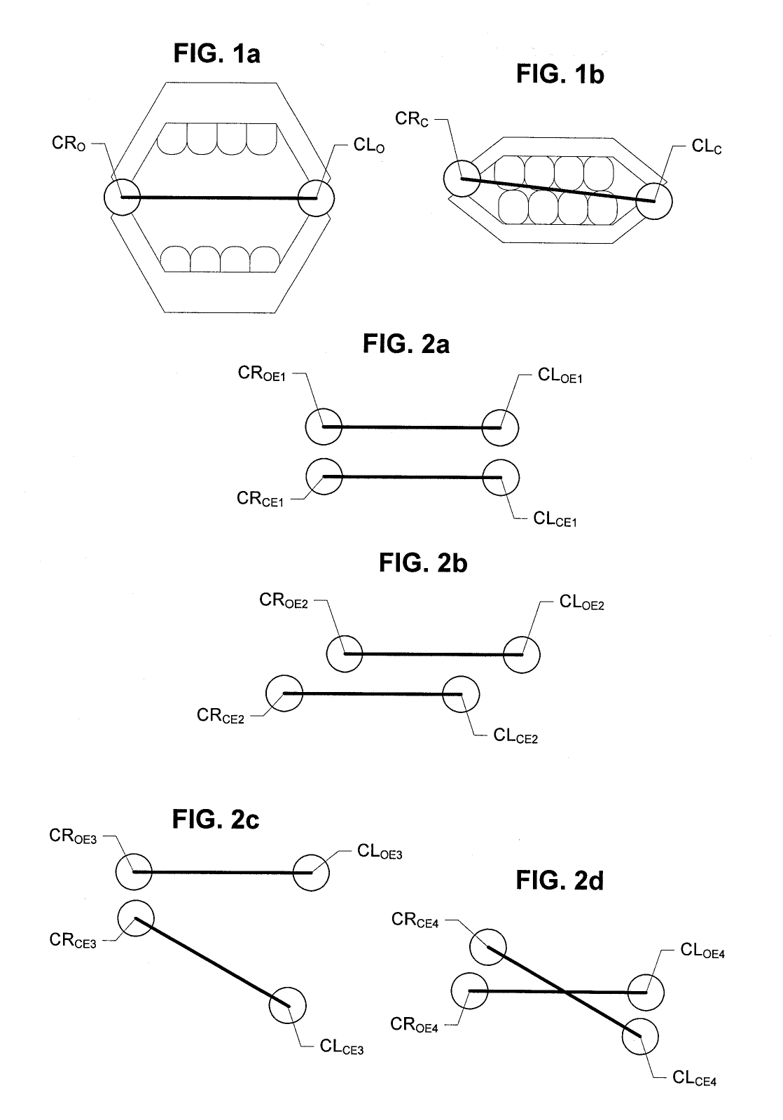

### DETAILED DESCRIPTION OF THE PREFERRED EMBODIMENT

This application relates in general to a method and apparatus for determining condyle displacement during jaw articulation for a patient. In the following detailed description of exemplary embodiments of the invention, reference is made to the accompanying drawings, which form a part hereof, and which is shown by way of illustration, specific exemplary embodiments of which the invention may be practiced. These embodiments are described in sufficient detail to enable those skilled in the art to practice the invention, and it is to be understood that other embodiments may be utilized, and other changes may be made, without departing from the spirit or scope of the present invention. The following detailed description is, therefore, not to be taken in a limiting sense, and the scope of the present invention is defined only by the appended claims.

Throughout the specification and claims, the following terms take the meanings explicitly associated therein, unless the context clearly dictates otherwise. Referring to the drawings, like numbers indicate like parts throughout the views.

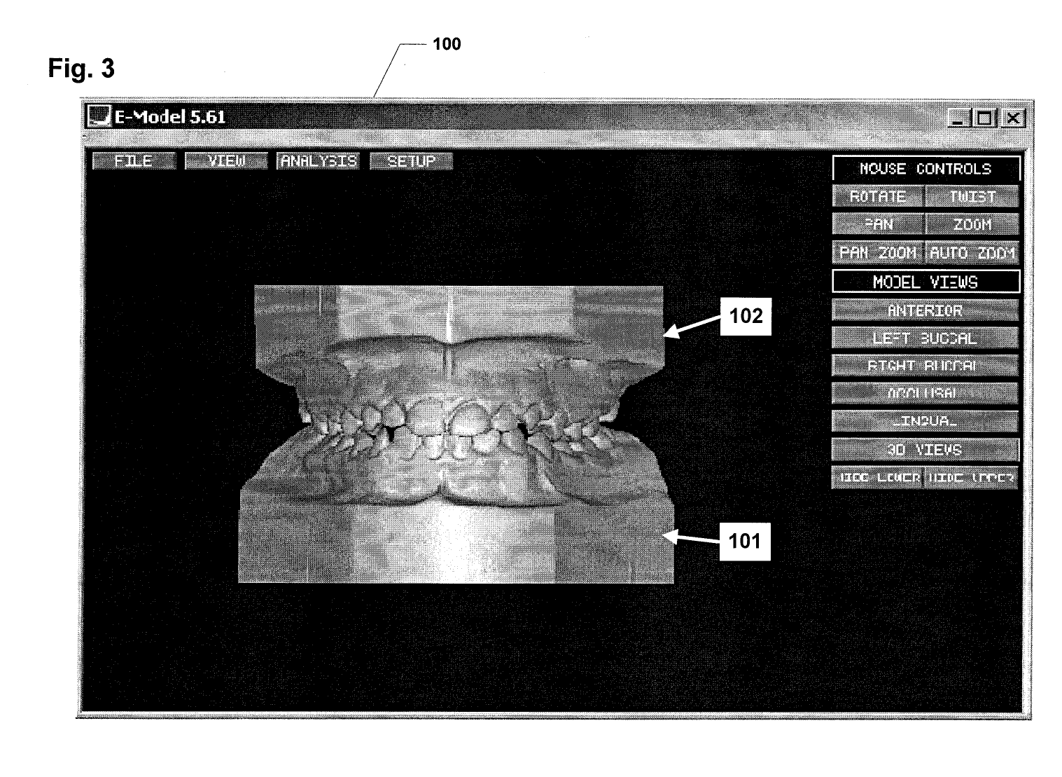

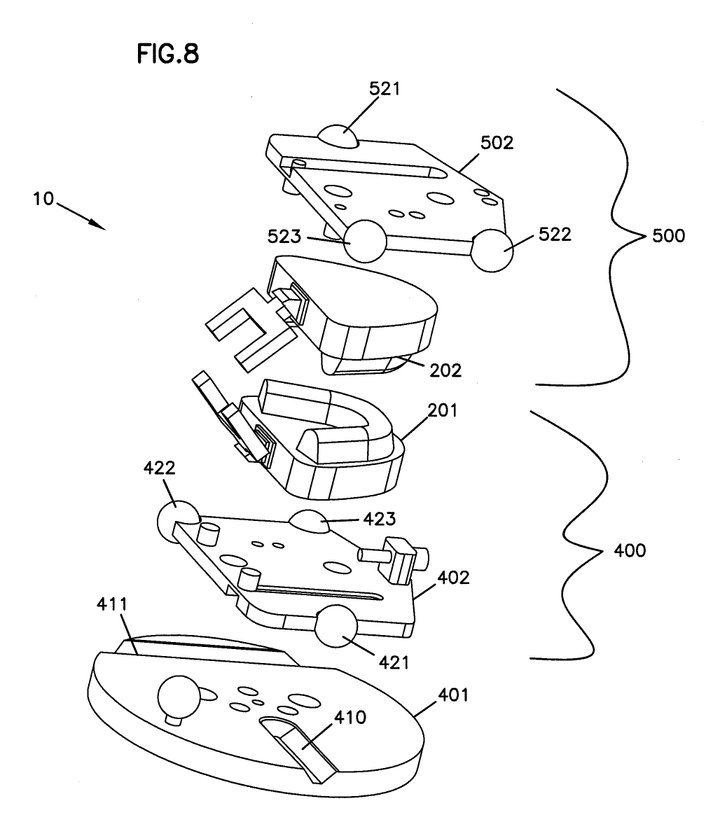

Turning to FIG. 3, one example embodiment of a computer-generated image 100 of a composite electronic model 103 includes a first and a second electronic model 101, 102. The electronic models 101, 102 correspond to physical models 201, 202 (best seen in FIG. 8) of a patient's mandible and maxilla, respectively. In one embodiment, the two models 101, 102 are generated separately, combined into a common coordinate system, and positioned together to demonstrate the interaction of the opposing teeth present on the maxilla and the mandible. Interaction of other points known relative to at least one of the electronic models 101, 102, a condyle for example, can also be displayed.

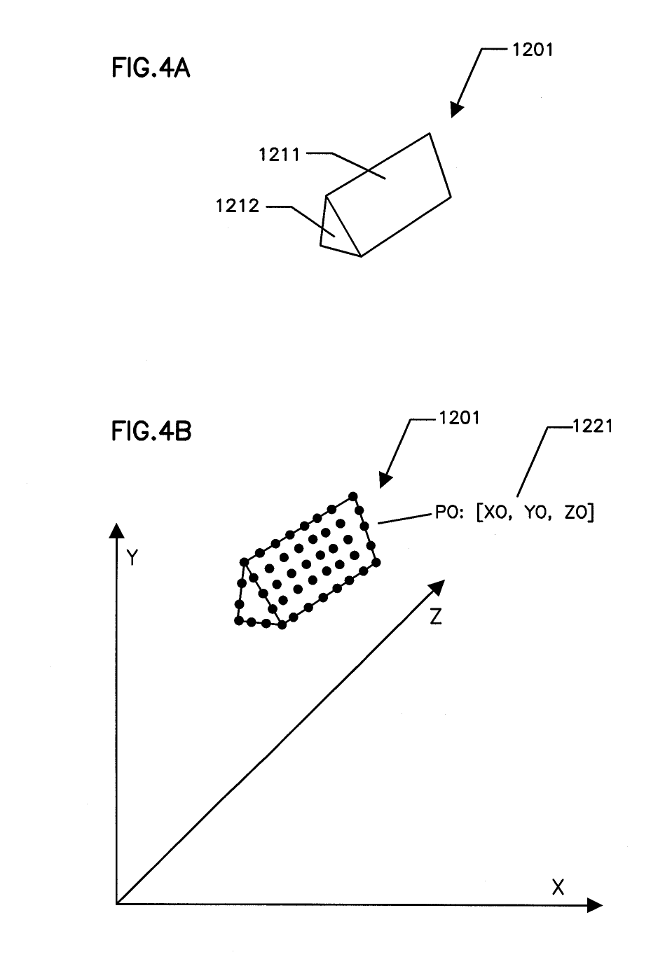

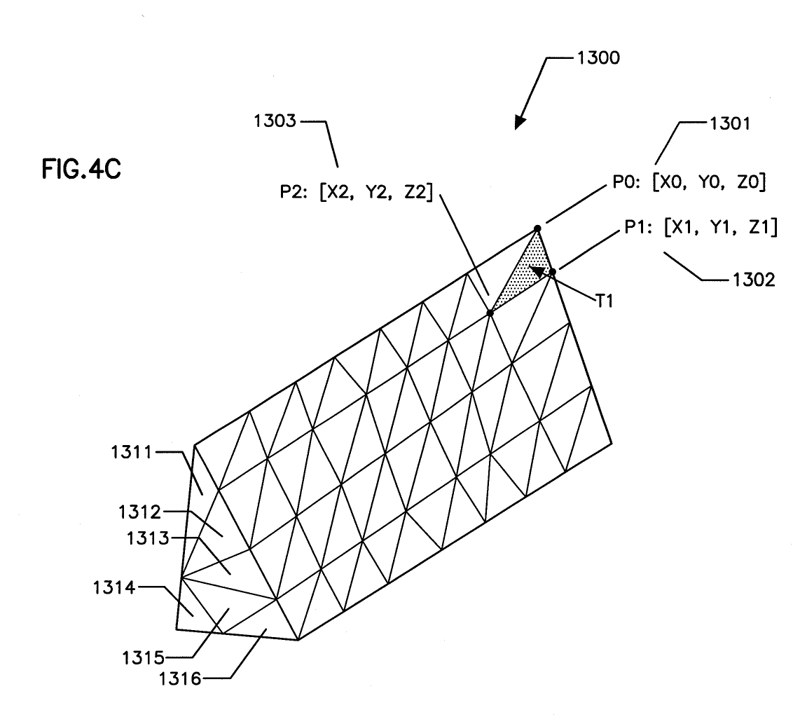

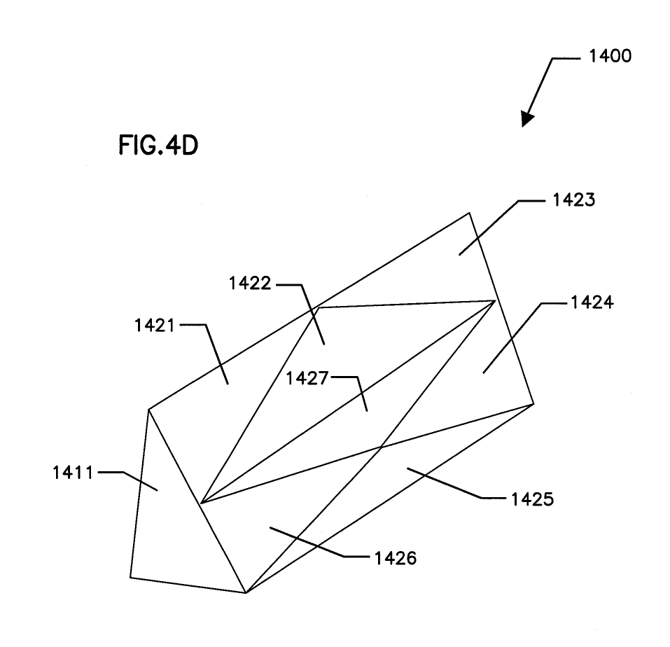

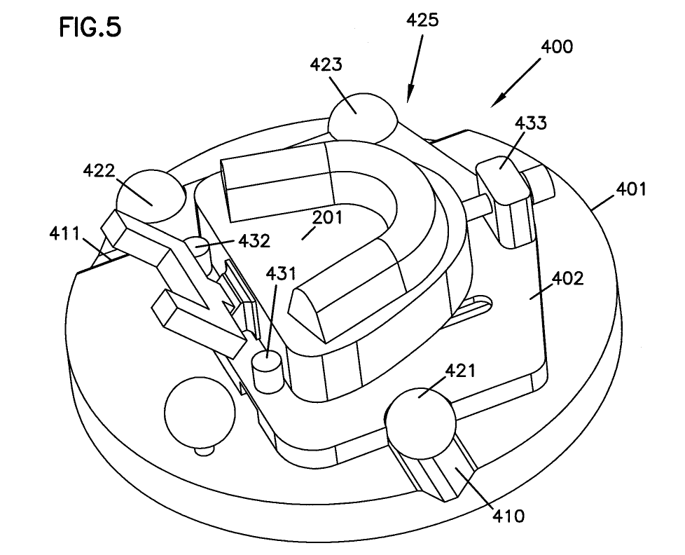

Referring now to FIGS. 4A-4D, the generation of electronic models from scanned data points of physical models will be briefly described. When a laser line scanning device or other suitable scanner passes a sensor over a surface of a physical model, a line of points corresponding to the position of the model's surface is obtained. In FIGS. 4A-4B, data points 1221 of a first and second surface 1211, 1212 of a physical object 1201 are specified using a three coordinate position P={X, Y, Z}. As the laser is moved within a scanning area of a multi-axis platform, the scanning device translates the data points 1221 to a coordinate system of the scanning device such that the collection of all points represents the points in a 3D coordinate system that corresponds to the surfaces 1211, 1212 of the model 1201. These data points 1221 are stored within a point cloud data file. It will be appreciated that only a first data point 1221 is explicitly shown as Po in FIG. 4B. However, a plurality of undesignated points is illustrated. Each of the other points may be identified as described in connection with FIG. 4C below.

Referring now to FIG. 4C, the point cloud data file is reduced to an original polygonal mesh 1300 of triangles in which the surfaces of the triangles are used to approximate the surfaces 1211, 1212 of the physical model 1201. Each triangle in the original polygonal mesh 1300 is specified using three points P0, P1, P2 corresponding to its three corners. For example, triangle T1 is specified using points P0 1301, P1 1302, and P2 1303 such that T1={P0, P1, P2}={[X0, Y0, Z0], [X1, Y1, Z1], [X2, Y2, Z2]}. The triangles in the original polygonal mesh may be created using any number of well-known methods for converting point position data into a polygonal mesh that approximates the surface of an object.

In FIG. 4D, a reduced polygonal mesh 1400 is generated by combining adjacent triangles in the original polygonal mesh 1300 when two or more triangles are sufficiently coplanar that they may be represented using a single triangle. For example, triangles 1311-1316 in FIG. 4C are reduced to triangle 1411 in FIG. 4D. Triangles 1421-1427 are also shown. The processing associated with this filtering operation controls the amount of triangle combination by setting a threshold relating to the minimum amount of deviation from a single plane for two or more triangles that is permitted before the two or more triangles are required to remain separate. This filtering process may be accomplished using a number of commercially available polygonal mesh processing products.

Referring now to FIGS. 5-7, an example configuration of scanning tools used in scanning physical models and converting them to electronic models will be described. FIG. 5 illustrates one embodiment of a scanning assembly 400 including a tooling plate structure 402 mounted to a base plate structure 401. The tooling plate structure 402 includes a set of reference points or markers 425. These reference points 425 may be arranged and configured according to any suitable distribution over the tooling plate structure 402. The assembly 400 further includes a physical model 201 of a dental impression mounted to the tooling plate 402. The physical model 201 is created from at least one dental impression taken of the patient.

One embodiment of the base plate structure 401 includes a plurality of alignment recesses for securing the tooling plate structure 402 to the base plate 401. In the example illustrated in FIG. 5, the plurality of alignment recesses include an x-axis alignment channel 411 and a y-axis alignment channel 410. These two alignment channels 410, 411 are perpendicular and co-planar within the plane defined by the top surface of the base plate structure 401. These two alignment channels 410, 411 are generally v-shaped such that the vertex of the channel defines the deepest point within the channel. In one embodiment, the plurality of reference points 425 includes a y-axis channel alignment sphere 421, a first x-axis channel alignment sphere 422, and a second x-axis channel alignment sphere 423. These three spheres 421, 422, 423 are defined by a radius corresponding to the size of the two alignment channels 410, 411 within the scanning base plate structure 401.

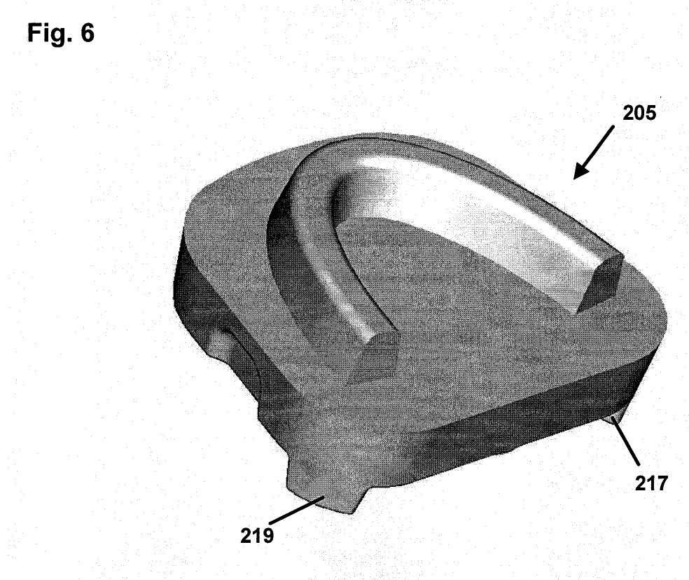

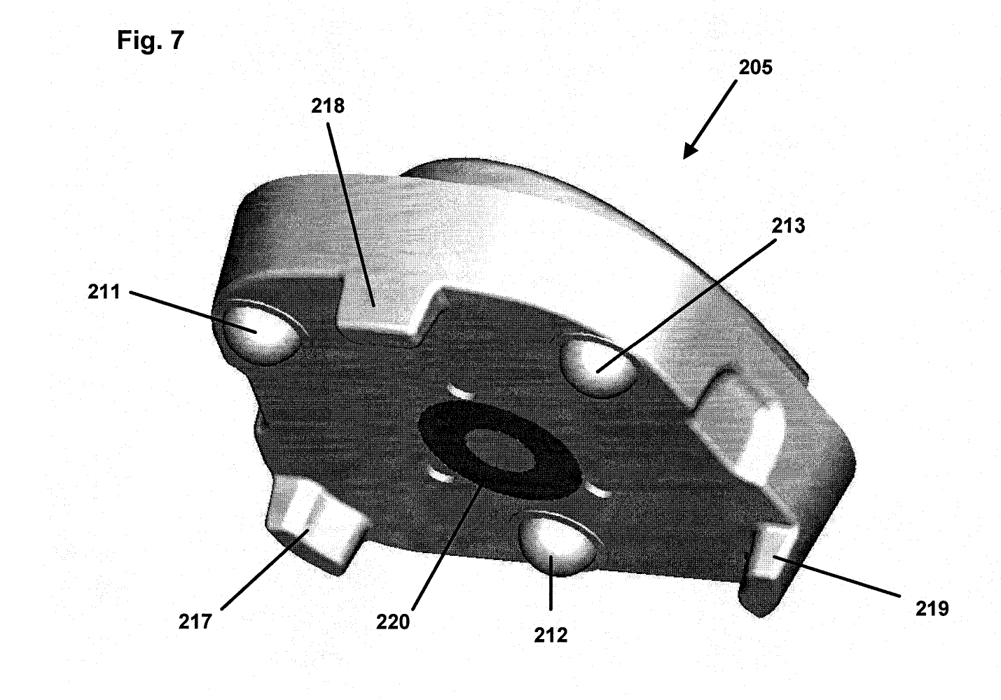

FIGS. 6-7 depict a partial, alternative embodiment of the assembly 400. FIG. 6 illustrates a first side of a physical model 205 configured to not require a tooling plate structure 402. FIG. 7 illustrates an opposite side of the physical model 205 shown in FIG. 6. Unlike the physical models 201, 202, the physical model 205 includes a plurality of directional protrusions 225 positioned along the side illustrated in FIG. 7. These directional protrusions 225 mate with the two alignment channels 410, 411 in much the same way as alignment spheres 421-423. According to one embodiment, these directional protrusions 225 include three directional hemispheres 211-213. Forming the directional hemispheres 211-213 directly onto the physical model 205 enables the physical model 205 to be easily replaced upon the scanning device or base plate structure 401 for scanning after being removed without having to realign the physical model 205 to a tooling plate structure 402.

In particular, to position the physical model 205 at a known and repeatable position relative to the scanning base plate structure 401, these spheres 211, 212, 213 are positioned to engage the two alignment channels 410, 411. This aligned position occurs because the first x-axis channel alignment sphere 212 and the second x-axis channel alignment sphere 213 position the physical model 205 at a known position relative to the scanning base plate structure 401 in the x-axis dimension. Similarly, the y-axis channel alignment sphere 211 engage the y-axis alignment channel 410 to position the physical model 205 at a known position relative to the scanning base plate structure 401 in the y-axis dimension. The combination of the two alignment channels 410, 411 and the three alignment spheres 211-213 enables the physical model 205 to be located at a single, repeatable position.

Another possible embodiment of the physical model 205 further includes a plurality of protruding members, which extend passed the hemispheres 211, 212, 213. In the example illustrated in FIG. 7, the plurality of protruding members includes three protruding members 217, 218, 219. The physical model 205 rests on these members 217, 218, 219 so that the hemispheres 211, 212, 213 do not become worn down. Yet another possible embodiment of the physical model 205 includes a metal washer 220 that enables the physical model 205 to be magnetically mounted to a scanning device, thereby better securing the physical model 205.

Referring now to FIG. 8, an exploded view of an example scanning assembly 10 is illustrated. The first assembly 400 and a second assembly 500, which includes a physical model 202 representing the maxilla of the patient, are mounted to the scanning base plate structure 401. In one embodiment, the first assembly 400 includes the tooling plate structure 402 having three alignment spheres 421-423 and the physical model 201 corresponding to the mandible of the patient. The second assembly 500 includes a physical model 202 corresponding to the maxilla of the patient and another tooling plate structure 502 including three alignment spheres 521-523. In an alternative embodiment, physical models similar to physical model 205 described in FIGS. 6-7 are used, in which case the tooling plate structures 402, 502 are not used.

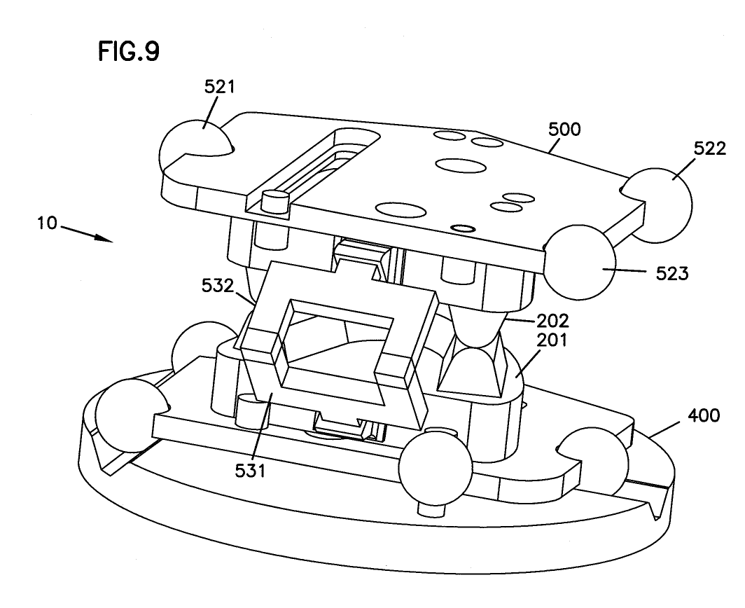

Referring now to FIG. 9-11, a combined electronic model 103 representing the maxilla and mandible of a patient within a common coordinate system can be generated from the two assemblies 400, 500. FIG. 9 illustrates a perspective view of one example embodiment of a scanning assembly 10 including the first and second assembly 400, 500. Each assembly 400, 500 also includes an articulation member 531, 532. These two articulation members are coupled together to position the second assembly 500 at a position relative to the first assembly 400 to simulate the interaction of the maxilla and the mandible of a patient. By manipulating the arrangements of the two articulation members 531, 532, the two physical models 201, 202 may be positioned into any desired position relative to each other.

According to one embodiment, the desired position is defined by a user who moves the two assemblies 400, 500 until the two physical models 201, 202 are in a specific position relative to each other. In another embodiment, the physical models 201, 202 may be positioned according to a bite position record. Common examples of bite positions recorded by dental specialists include centric occlusion, centric relation, a protrusion bite, and a lateral excursion bite. One possible embodiment of such a bite record includes a bite wax impression obtained from the patient. The bite wax is created by having the patient bite down on a strip of wax, thereby leaving an impression showing the placement of the patient's teeth. The bite wax can then be placed in between the two physical models 201, 202 to allow proper alignment of the models. Another possible embodiment of such a bite record includes a medical image showing the patient's jaws or teeth.

Still referring to FIG. 9, each of the assemblies 400, 500 is scanned separately from the combined assembly 10. Separate electronic models 101, 102 are generated from these two assemblies 400, 500, each model 101, 102 being defined within a separate coordinate system T, O, respectively. To generate the combined electronic model 103, the two assemblies 400, 500 are arranged into a desired position and the combined assembly 10 is scanned. In one embodiment, when the combined assembly 10 is scanned, only the locations of the alignment spheres 521-523 on the second assembly 500 are determined. From this information, the location of any point on the second electronic model 102 may be transformed to a point on the coordinate system T used to define the first electronic model 101.

In one embodiment, the combined assembly 10 is typically scanned before either of the assemblies 400, 500 is individually scanned. In another embodiment, the combined assembly 10 is scanned after the first assembly 400 including the first physical model 201 is individually scanned. The first assembly 400 occupies the same position on the scanner while being scanned individually and while combined with the second assembly 500. Therefore, the combined assembly 10 will be scanned within the same coordinate system T as the first assembly 400. The position points of the second assembly 500 are converted from the coordinate system O into position points in the coordinate system T in order to place all of the points used to define the two electronic models 101, 102 within a single coordinate system.

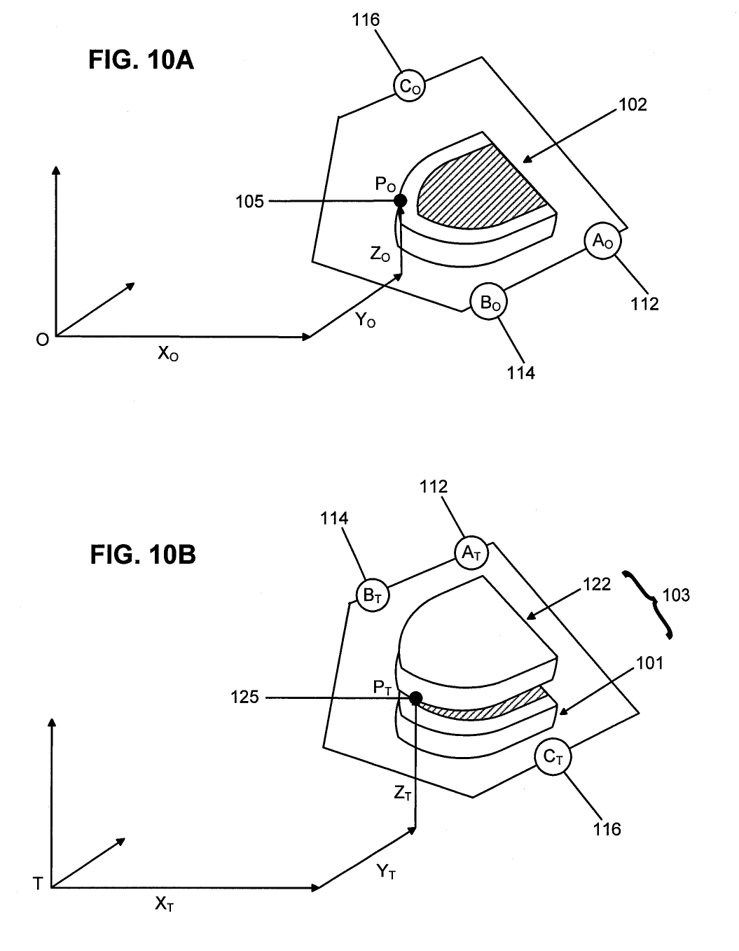

Referring now to FIGS. 10A and 10B, the position of the second electronic model 102 is determined within the same coordinate system T as the first electronic model 101. FIG. 10A illustrates a schematic of the second electronic model 102, which corresponds with physical model 202 of a maxilla, defined within the coordinate system O. In the illustrated embodiment, the electronic model 102 is displayed dentition side up because that is how the corresponding physical model 202 is scanned in order to obtain positional data on the dentition. The initial electronic model 102 has a point P_{O} 105 located within coordinate system O, such that P_{O}={X_{O}, Y_{O}, Z_{O}}. The relative positions of electronic reference points 112, 114, 116 at positions A_{O}, B_{O}, and C_{O}, respectively are also depicted. In one embodiment, the reference points 112, 114, 116 refer to the positions of the reference points 525 on the tooling plate 502 (see FIG. 5). In another embodiment, the reference points 112, 114, 116 represent the three protruding reference points 211-213 (e.g., or hemispheres) on the physical model 205 (see FIG. 7).

Referring now to FIG. 10B, the electronic model 102 is transformed into an electronic model 122 defined within the coordinate system T. FIG. 10B illustrates the transformed electronic model 122 displayed with the electronic model 101. The transformed electronic model 122 is now right side up and occupies a position over the electronic model 101 of the mandible. A point P_{T} 125 on the transformed electronic model 122 corresponds to the point P_{O} 105 on the electronic model 102. The point P_{T} is located within the coordinate system T such that P_{T}={X_{T}, Y_{T}, Z_{T}}. Reference points 112, 114, and 116 have also been transformed to occupy positions A_{T}, B_{T}, and C_{T}, respectively. Electronic model 101 and transformed electronic model 122 form the combined electronic model 103.

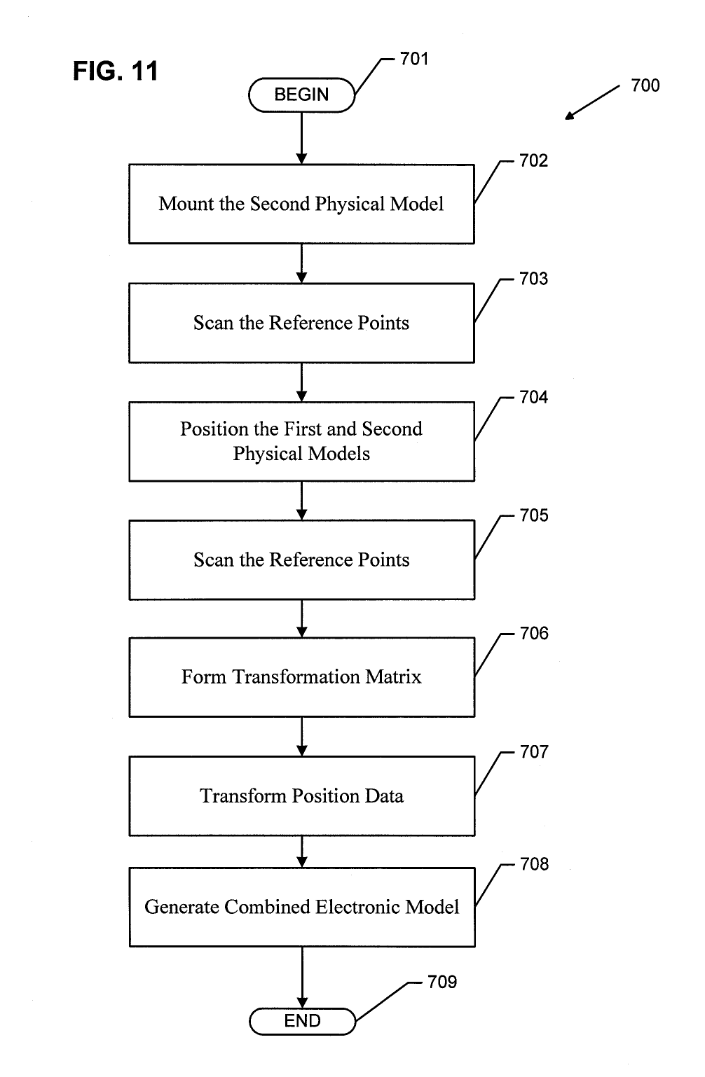

FIG. 11 illustrates a flow chart 700 depicting the steps used to transform the point P_{O} 105 on the electronic model 102 to the point P_{T} 125 on the transformed electronic model 122. These steps will be described herein with reference to FIGS. 9, 10a and 10b. The process assumes that the first physical model 201 has already been scanned and that the corresponding electronic model 101 has already been generated. The process begins at module 701 and proceeds to mounting operation 702 in which the second physical model 202 is mounted dentition side up on the scanning device (not shown). Next, scanning operation 703 includes scanning the dentition portion of the physical model 202 and the reference points 225 on the second physical model 202 to obtain positional data. In one embodiment, this positional data is stored in memory as a point cloud data file. In another embodiment, the positional data is used to generate an initial electronic model 102 of the maxilla.

The process proceeds to positioning operation 704 in which the first and second physical models 201, 202 are positioned on the scanner into a desired position. For example, in dental modeling, the first and second physical models 201, 202 are positioned so as to represent the relationship between the maxilla and mandible of a patient in various bite positions. In various embodiments, methods of positioning include bite records, medical images, and any other suitable method.

The reference points 225 are scanned in reference scanning operation 705. The positional data obtained from the scan corresponds to reference points 112, 114, and 116 on the transformed electronic model 122. According to one embodiment, the reference points 225 include the alignment spheres 521-523 on the tooling plate structure 502. According to another embodiment, the reference points 225 include the directional protrusions 211-213 on the physical model 205.

In matrix formation operation 706, a transformation matrix [M] is created using the positions of the reference points 112, 114, 116 on the initial electronic model 102 and the positions of the reference points 112, 114, 116 on the transformed electronic model 122. The transformation matrix [M] is created based on an algorithm known in the art for mapping at least three points from one position in three-dimensional space to another. In one embodiment, the transformation matrix [M] is a four-by-four matrix [M4]. As mentioned above with respect to FIGS. 10a and 10b, a point P_{O} on the electronic model 102 can be defined as having a position P=(X_{O}, Y_{O}, Z_{O}). In the example of a four-by-four matrix, by adding a fourth dimension to the point coordinate and assuming the fourth point to be equal to 1, so that P_{O}=(X_{O}, Y_{O}, Z_{O}, 1), the point P_{O} can be multiplied by the transformation matrix [M4] to yield the translated point P_{T}=(X_{T}, Y_{T}, Z_{T}, 1).

The process then proceeds to transformation operation 707 in which each point of positional data scanned from the second physical model 202 is transformed by multiplying the point by the transformation matrix [M4]. Once the position data transformation operation 707 completes, operation 708 uses the transformed data points to generate a combined electronic model 103 representing the maxilla and mandible. This combined electronic model 103 enables a user to manipulate one model while keeping track of its locations relative to the other. The process ends at module 709.

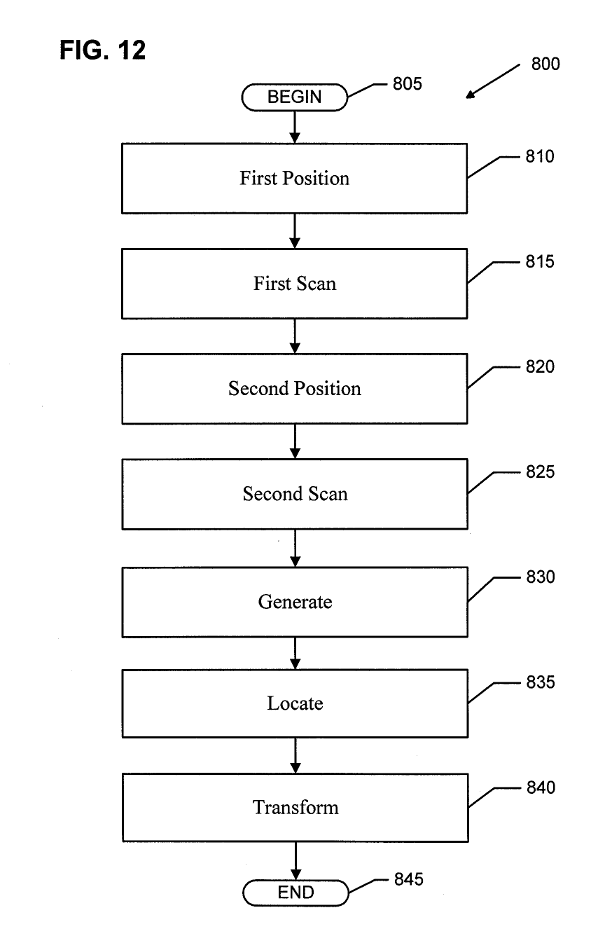

Referring now to FIGS. 12-15, another possible embodiment of the invention enables a user to determine how the left and/or right condyle of a patient will be displaced during jaw articulation (i.e., or when the patient's mandible is moved relative to the maxilla). The displacement of each condyle point CR, CL is calculated using a transformation matrix [M] created from positional data obtained from scans of the reference points 225 on the second physical model 202 when arranged in two or more bite positions.

FIG. 12 illustrates an example operation flow for a process 800 for generating a condyle transformation matrix [M_{C}]. The process 800 uses the first and second physical models 201, 202 (or two alternative physical models 205) corresponding to the mandible and maxilla, a scanning device (not shown), and a scanning assembly 10 substantially as described above with respect to FIGS. 6, 7, 9, 10a, and 10b. The process assumes that electronic images 101, 122 of the physical models 201, 202 and the combined electronic model 103 have already been generated and converted to a common coordinate system. Alternatively, the electronic models 101, 122, 103 can all be generated after completing the process 800, or not at all.

The process 800 begins at module 805 and proceeds to positioning operation 810 in which a first and second physical model 201, 202 are positioned according to a first bite record using the techniques described above with reference to FIG. 9. This bite record can be thought of as “home base” so to speak for the electronic model 103. All transformed electronic model positions will be generated with reference to this first bite record position. Consequently, condyle displacement will be measured with respect to the first bite position.

First scanning operation 815 scans the position of each directional protrusion 225 on the second physical model 202 using the scanning device to create a first set of positional data. Next, in repositioning operation 820, the first and second physical models 201, 202 are repositioned according to a second bite record. In second scanning operation 825, the directional protrusions 225 again are scanned on the second physical model 202 to create a second set of positional data. According to one embodiment, operations 820 and 825 are repeated multiple times for a variety of bite records. For each successive bite record, a different transformation matrix [M_{C}] can be created to define jaw articulation between the bite record and the first bite record (i.e., home base).

Matrix formation operation 830 uses the data point corresponding to the center of each of the directional protrusions 225 taken from two of the bite scans to create the transformation matrix [M_{C}]. The first and second sets of positional data yield a four-by-four transformation matrix [M_{C}4]. The transformation matrix [M_{C}4] can be used to determine the displacement of any point on the second electronic model 122 when the physical model 202 is moved from the first bite position to the second bite position.

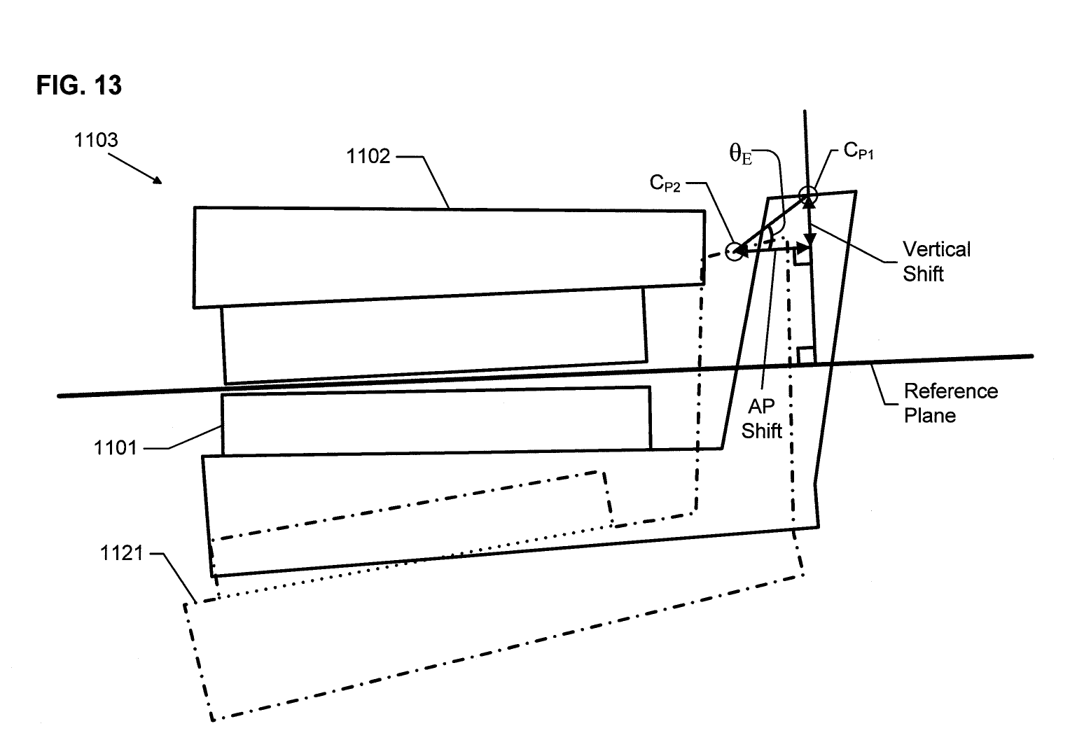

The process now proceeds to condyle locating operation 835, which includes determining the positions Pc=(Xc, Yc, Zc) of one or both of the patient's condyles within the common coordinate system T. This operation 835 is described in detail herein with respect to FIGS. 13-15. Transforming operation 840 transforms the position of the condyle Pc from a first bite position Pc₁ to a second bite position Pc₂ using the transformation matrix [M_{C}]. The process ends at module 845.

Using the transformation matrix, the user can view the electronic model 103 of the patient's mandible and maxilla in both the first bite position and the transformed bite position. Generally, when positioning the physical models 201, 202 on the combined assembly 10, the second model 202 is positioned while the first model 201 remains stationary. However, when a patient forms the different bite positions with her jaws, the mandible moves while the maxilla remains stationary. In order to seem more natural to the user, therefore, one embodiment displays the mandible of electronic model 103 (i.e., or electronic model 101) moving between bite positions while the maxilla (i.e., or electronic model 122) remains stationary.

The transformation matrix [M_{C4}] transforms the position of each of the points on the electronic model 101 within the coordinate system T to the position that point would occupy if the electronic model 101 were moved to the second bite position. According to another possible embodiment, the electronic model 122 of the maxilla would be shown moving. Furthermore, once the position of each point on the electronic model 103 is known for each bite position, it is possible to interpolate the positions each point would progress through when moving from the first bite position to any of the other bite positions. In one embodiment, the combined electronic model 103 is displayed moving through these points as well.

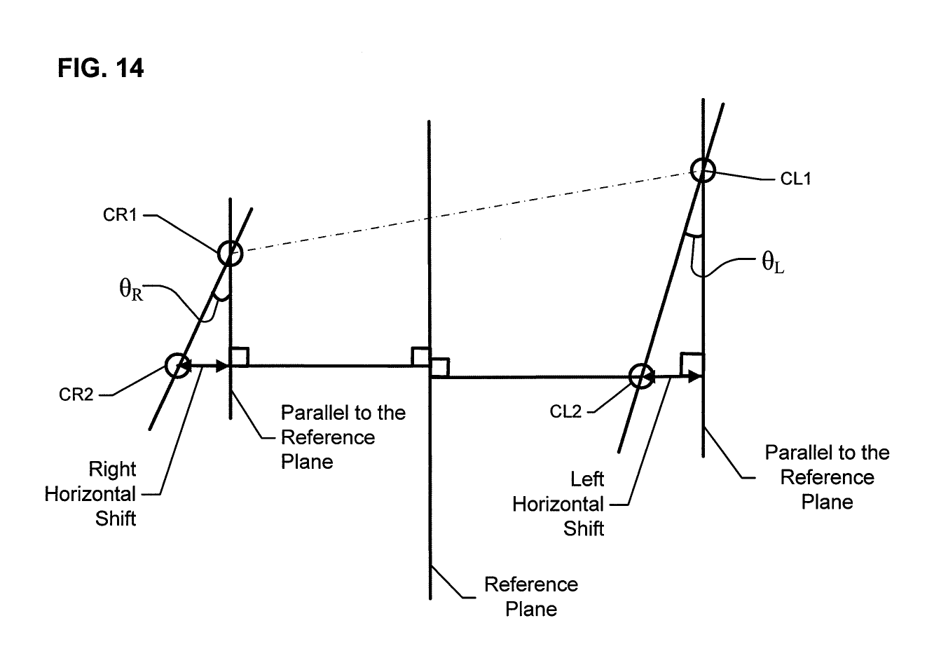

Referring now to FIGS. 13-14, determining condyle displacement includes determining over what distance and in what direction a patient's condyle shifts between bite positions. For example, the shift in condyle position can be described as displacement along three dimensions (e.g., an x-axis, a y-axis, and a z-axis). The axes are defined relative to a reference plane. In various embodiments, reference planes include an occlusal plane, a Frankfort Horizontal plane, a coronal plane, a sagittal plane, and any other such suitable plane. In one embodiment, the three measurements taken to calculate condyle displacement are the vertical shift, the anterior-posterior (AP) shift, and the horizontal shift.

An example method of measuring the vertical and AP shift of a condyle is illustrated in FIG. 13. A combined electronic model 1103 including an electronic model 1101 of a mandible and an electronic model 1102 of a maxilla is positioned in a first bite position. A reference plane is also shown extending between the maxilla and mandible. An electronic model 1121 representing the mandible in a second bite position is also shown in dashed lines. The position of the condyle C_{P1}, C_{P2} on each electronic model 1101, 1121, respectively, is indicated.

According to one embodiment, measuring the vertical shift between the condyle positions C_{P1}, C_{P2}, includes drawing a first line through the first condyle position C_{P1} such that the first line is perpendicular to the reference plane. A second line is drawn through the second condyle position C_{P2} such that the second line is perpendicular to the first line (i.e., parallel with the reference plane). The vertical shift of the condyle refers to the distance between the first condyle position C_{P1} and the point of intersection of the first and second lines. The AP shift refers to the distance between the second condyle position C_{P2} and the point of intersection of the first and second lines. In some embodiments, a condylar angle θ_{E} between the second line and a line connecting the two condyle position points C_{P1}, C_{P2} is also of interest.

An example method of measuring the horizontal shift in condyle position is illustrated in FIG. 14. Schematic representations of a patient's right condyle CR1, CR2 and left condyle CL1, CL2 in a first and second bite position, respectively, are illustrated in FIG. 14. A reference plane is also shown. In one embodiment, the reference plane is the sagittal plane of the patient. In another embodiment, the reference plane is the midline plane of the patient. However, other such reference planes can be used.

In one embodiment, determining the horizontal shift of the right condyle includes drawing a first line through the right condyle in one of the bite positions (e.g., CR2) such that the line is perpendicular to the reference plane. A second, orthogonal line is drawn through the other right condyle (e.g., CR1) such that the second line intersects the first line at a right angle. The horizontal shift of the condyle refers to the distance between the point of intersection of the first and second line and the position of the right condyle CR2 through which the first line passes. The horizontal shift for the left condyle is determined in substantially the same fashion. In some embodiments, the user is also interested in the Bennett angle θ_{R}, θ_{L} for each condyle. The Bennett angle is the angle between the reference plane and a third line connecting the condyle position points for the two bite positions.

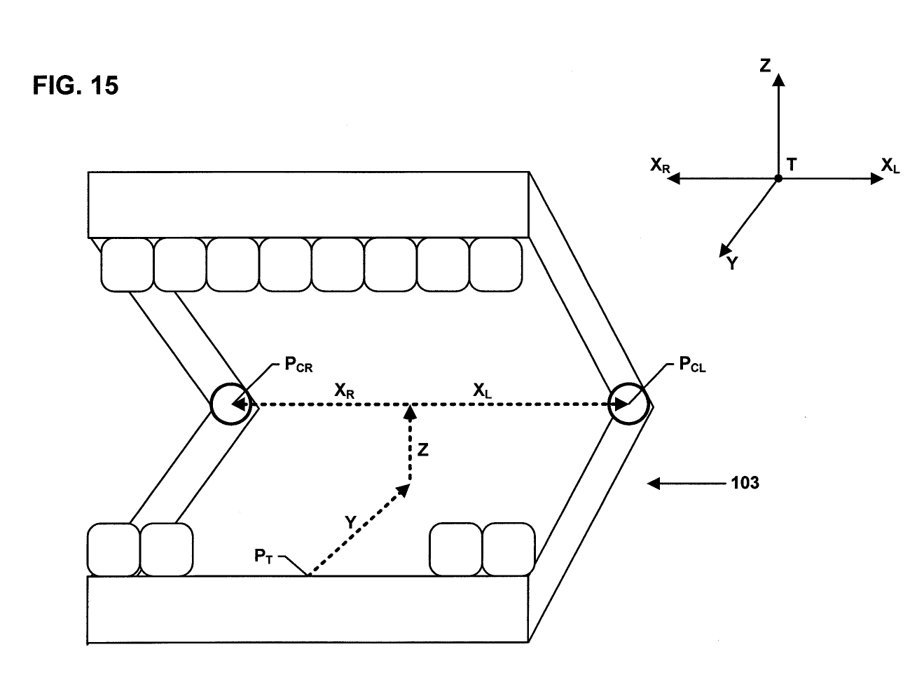

Referring now to FIG. 15, determining displacement of the patient's condyle includes locating the condyle in relation to a point on the scanned positional data forming one of the electronic models 101, 122, 103. FIG. 15 illustrates one example method of determining the location of the patient's condyle including measuring the distance along an x-axis, a y-axis, and a z-axis of a coordinate system T between a patient's condyle Pc and a known point position P_{T} on the patient's mandible. In varying embodiments, the point Pc can refer to either the patient's left condyle P_{CL} or the patient's right condyle P_{CR}. In one embodiment, the point P_{T} corresponds to a selected point on the electronic model 103. Because the point P_{T} is known within the coordinate system T, the position of the condyle Pc in another bite position can be determined by using the transformation matrix [M_{C}] described above in FIGS. 10(a-b) and 11. Also, as discussed above, it is possible to interpolate the positions PC through which the condyle would progress when moving from one bite position to the another.

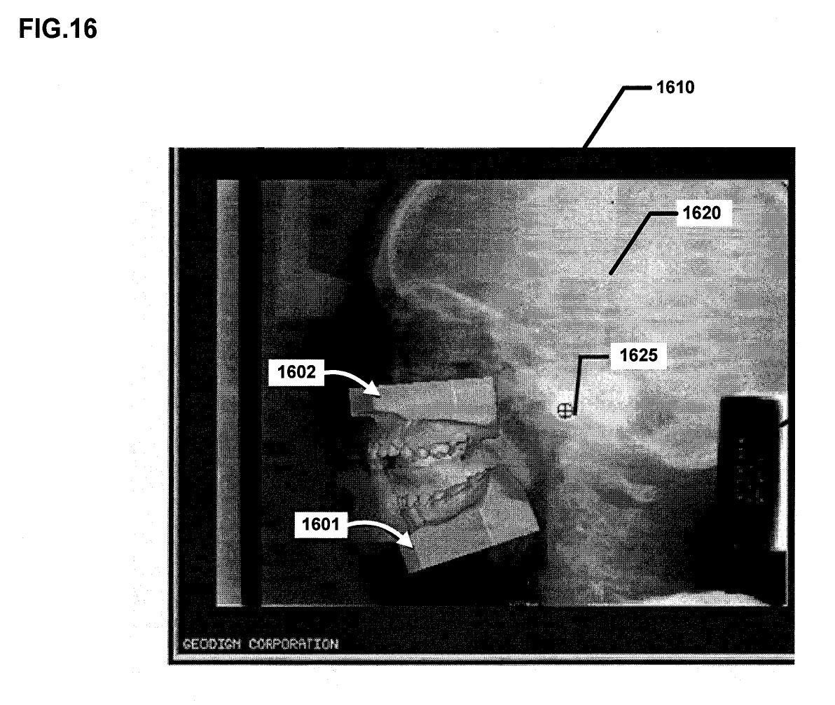

Referring to FIG. 16, in one embodiment, an electronic copy of a physiological image is used to determine a position of the condyle Pc along at least a first and second axis in relation to other physiological structures of the patient. Examples of medical images include a Cephalometric tracing, a photograph, an X-ray, or any other similar image. For example, FIG. 16 illustrates using a digital copy of an X-ray 1610 to visually determine the y-axis and z-axis values for the position Pc of the condyle.

Electronic models 1601, 1602 (i.e., or a combined electronic model 1103) representing the mandible and the maxilla are superimposed upon the digital copy of the X-ray 1610 of the patient's skull 1620. The X-ray 1610 is rotated and/or shifted relative to the electronic models 1601,1602 so that the X-ray 1610 is oriented similarly to the electronic models 1601, 1602. The X-ray 1610 is then resized so that the sizes of the patient's mandible and maxilla in the X-ray 1610 correspond to the sizes of the electronic models 1601, 1602. Positioning, orienting, and sizing the X-Ray 1610 as such substantially places the points on the X-ray 1610 in the same coordinate system T as the electronic models 1601, 1602. A point 1625 on the X-ray 1610 is then selected to define the y-axis position Pcy and z-axis position Pcz of the patient's condyle on the X-ray 1610.

In one embodiment, a user inputs the x-axis position Pcx of each condyle based on physical measurements. In another embodiment, a second physiological image taken at a different orientation (e.g., an occlusal view) can be used to obtain the x-axis position Pcx value substantially as described herein. According to another possible embodiment, the x-axis, y-axis, and/or z-axis positions Pcx, Pcy, Pcz of each condyle are determined by using a face bow, a digitization device (e.g., as described below) or other physical measuring device. In another embodiment, the selection of the point 1625 or the x-axis position Pcx is based on a visual determination made by the user. In yet another embodiment, computer software calculates the condyle's position 1625.

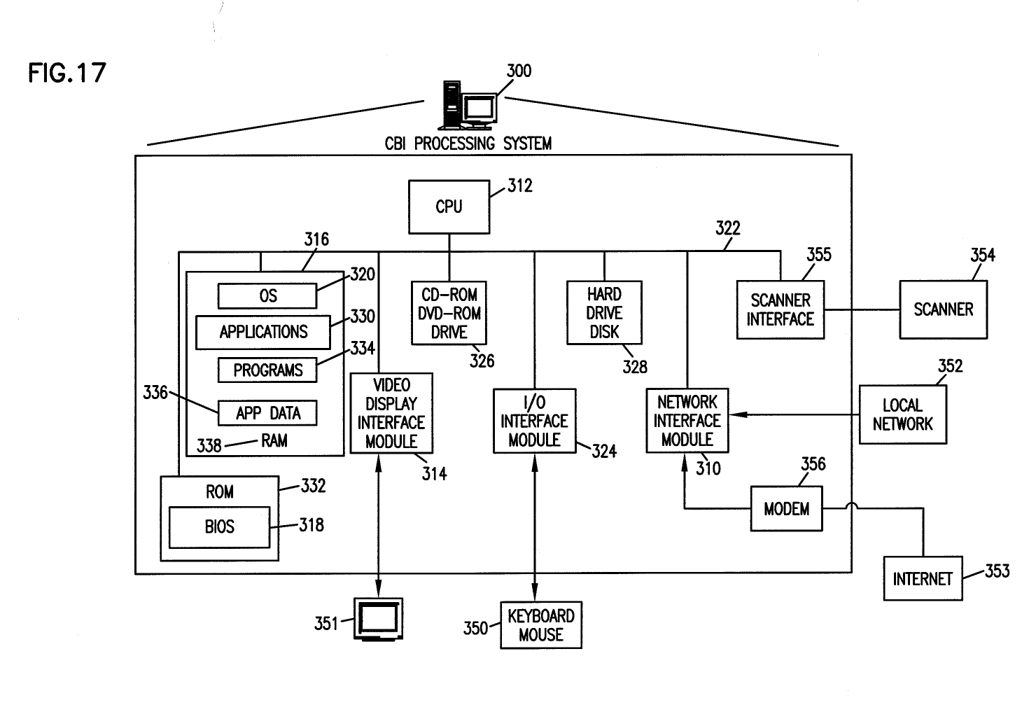

FIG. 17 illustrates one possible embodiment of a computing system for generating, manipulating, and storing the various electronic models and/or positional data. The processing system 300 is operative to provide a dental scanning coordinate processing system. Those of ordinary skill in the art will appreciate that the dental scanning coordinate processing system 300 may include many more components than those shown in FIG. 17. However, the components shown are sufficient to disclose an illustrative embodiment for practicing embodiments disclosed herein. For example, those of ordinary skill in the art will appreciate that a network interface unit 310 includes the necessary circuitry for coupling the dental scanning coordinate system processing system 300 to a network of other computing systems 352, 353, and is constructed for use with various communication protocols including the TCP/IP protocol. In some embodiments, the network interface unit 310 is a card contained within neural network training and data collection system.

The dental scanning coordinate system processing system 300 also includes processing unit 312, video display adapter 314, and a mass memory 316, all coupled via bus 322. The mass memory generally includes RAM 338, ROM 332, and one or more permanent mass storage devices, such as hard disk drive 328, a tape drive, CD-ROM/DVD-ROM drive 326, and/or a floppy disk drive (not shown). The mass memory stores an operating system 320 for controlling the operation of the dental scanning coordinate processing system 300. It will be appreciated that this component may include a general purpose server operating system as is known to those of ordinary skill in the art, such as UNIX, MAC OS™, LINUX™, OR Microsoft WINDOWS NT®. Basic input/output system (“BIOS”) 318 is also provided for controlling the low-level operation of processing system 300.

The mass memory as described above includes another type of computer-readable media, namely computer storage media. Computer storage media may include volatile and nonvolatile, removable and non-removable media implemented in any method or technology for storage of information, such as computer readable instructions, data structures, program modules or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

In some embodiments, the mass memory also stores program code and data for providing a software development and neural network analysis and training system. More specifically, the mass memory stores applications including common coordinate system application program 330, programs 334, and similar data processing applications 336. The common coordinate system application program 330 includes computer executable instructions which, when executed by the computer system 300, perform the logic desired herein.

Dental scanning coordinate system processing system 300 also includes input/output interface 324, Video/Display interface 314, and scanning interface 355 for communicating with external devices, such as a mouse or keyboard 350, scanner 354, display screen 351, or other input devices not shown in FIG. 17. Likewise, other embodiments of a dental scanning coordinate system processing system 300 further include additional mass storage facilities such as CD-ROM/DVD-ROM drive 326 and hard disk drive 328. In one embodiment, the hard disk drive 328 is utilized by the dental scanning coordinate system processing system 300 to store, among other things, application programs, databases, and program data used by the common coordinate system application program 330.

The operation environment illustrated in FIG. 17 is only one example of a suitable operating environment and is not intended to suggest any limitation s to the scope of use or functionality of the invention. Other well known computing systems, environments, and/or configurations that may be suitable for use with the invention include, but are not limited to, personal computers, server computers, held-held or laptop devices, multiprocessor systems, microprocessor-based systems, programmable consumer electronics, network PCs, minicomputers, mainframe computers, distributed computing environments that include any of the above systems or devices, and the like.

The invention may also be described in the general context of computer-executable instructions, such as program modules, executed by one or more computers or other devices. Generally, program modules include routines, programs, objects, components, data structures, etc. that perform particular tasks or implement particular abstract data types. Typically the functionality of the program modules may be combined or distributed in desired various embodiments.

A processing device attached to a communications network typically includes at least some form of computer readable media. Computer readable media can be any available media that can be accessed by these devices. By way of example, and not limitation, computer readable media may comprise computer storage media and communication media. Computer storage media includes volatile and non-volatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by process devices.

Communication media typically embodies computer readable instructions, data structure, program modules or other data in a modulated data signal such as a carrier wave or other transport mechanism and includes any information delivery media. The term “modulated data signal” means a signal that has one or more of its characteristics set or changed in such a manner as to encode information in a signal. By way of example, and not limitation, communication media includes wired media such as a wired network or direct-wired connection, and wireless media such as an acoustic, RF, infrared and other wireless media. Combinations of any of the above should also be included within the scope of computer readable media.

Additionally, the embodiments described herein can be implemented as a logical operation performed by a programmable processing device. The logical operation of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

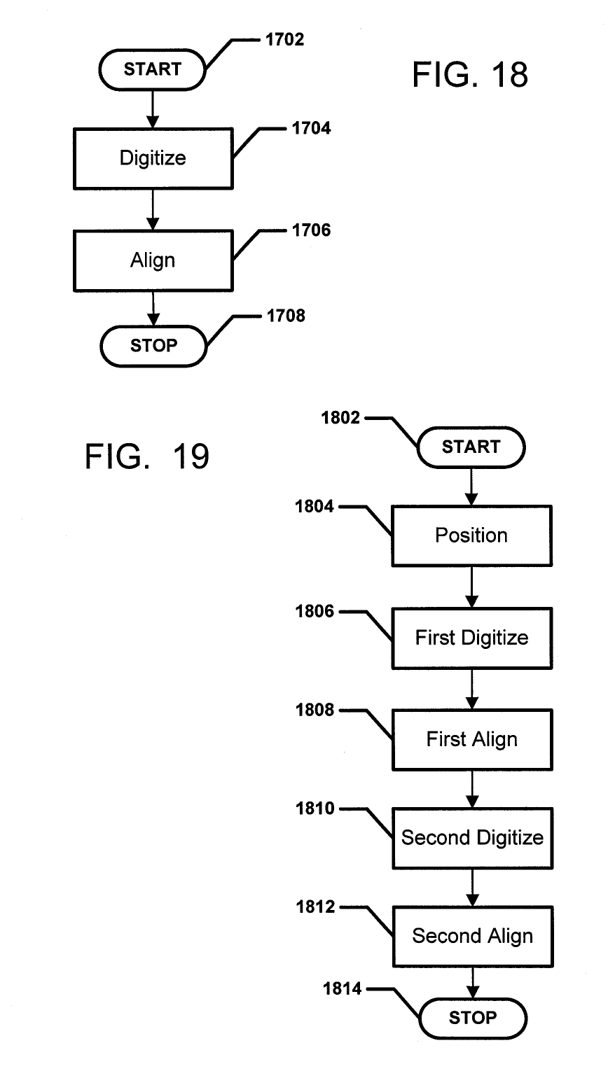

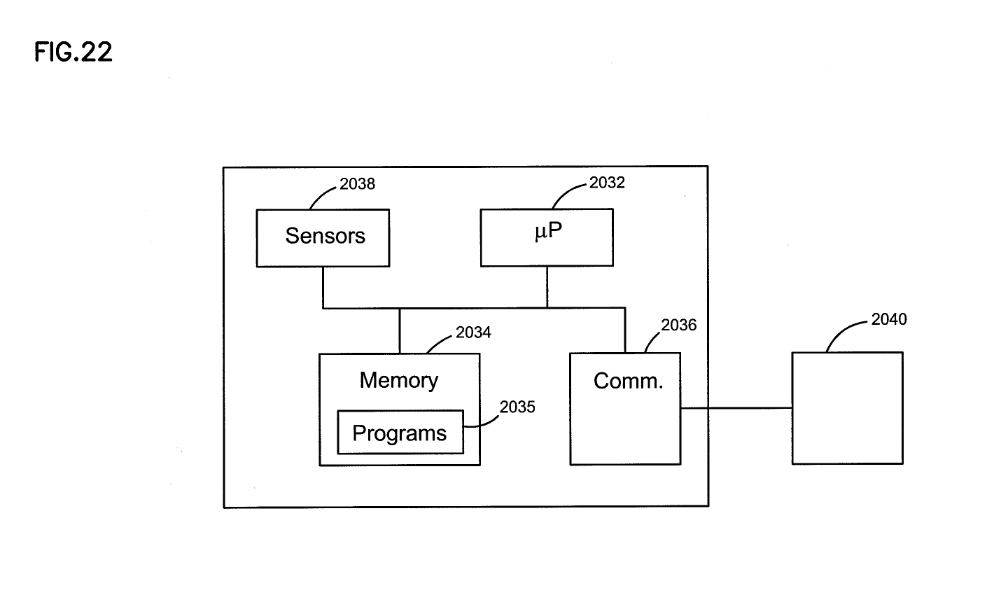

Referring now to FIGS. 18-27, jaw alignment can be simulated based on points obtained directly from the patient rather than from physical models. FIG. 18 illustrates an operational flow for an alternative mapping process 1700 for properly positioning previously generated electronic models of the patient's upper and lower dental arches relative to one another. The mapping process 1700 begins at start module 1702 and proceeds to a digitize operation 1704.

The digitize operation 1704 obtains coordinates for a selected point on the patient corresponding to a point on a previously generated electronic model. For example, the digitize operation 1704 can obtain coordinates for a point on the patient's mandible that corresponds to a point on the electronic model 101. The coordinates of the previously generated electronic model are known within a first coordinate system. The obtained coordinates are typically known within a second coordinate system.

An align operation 1706 positions the previously generated electronic model within the second coordinate system so that the point on the electronic model corresponding to the selected point is positioned at the obtained coordinates. The process 1700 ends at stop module 1708. Typically, the mapping process 1700 is repeated to obtain at least three points on the patient corresponding to points on each electronic model.

FIG. 19 illustrates an operational flow for one example alignment process 1800 for aligning an electronic model representing the maxilla with an electronic model representing the mandible of the patient. Typically, the electronic model representing the mandible has coordinates known within a first coordinate system and the electronic model representing the maxilla has coordinates known within a second coordinate system.

The alignment process 1800 begins at start module 1802 and proceeds to a position operation 1804. The position operation 1804 arranges the patient's mandible and maxilla in a first position. For example, the position operation 1804 can position the patient's mandible and maxilla into an open mouth position.

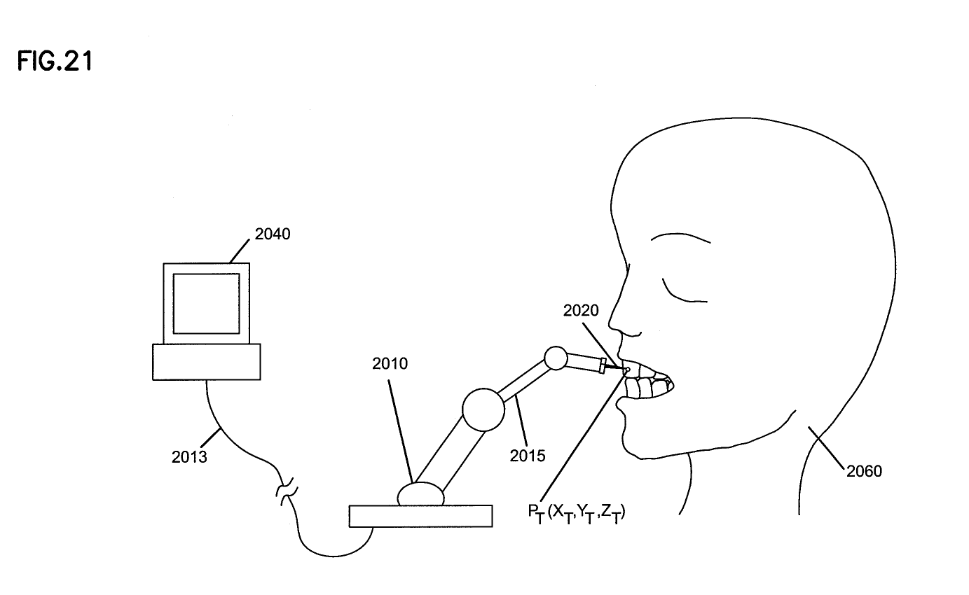

A first digitize operation 1806 obtains coordinates within a third coordinate system for at least three points on the patient's mandible (e.g., on the lower dentition, gumline, or any other structure represented in the electronic model) while the mandible is held in the first position. The obtained points can be taken simultaneously or sequentially, depending on the system used to obtain the points. One example digitizing system will be discussed herein with respect to FIGS. 21-24. Additional points can be taken to increase the accuracy of the simulation.

A first align operation 1808 maps corresponding coordinates of the electronic model of the patient's mandible to the obtained coordinates within the third coordinate system. Because at least three points were obtained, the electronic model can be placed and oriented within the third coordinate system. The electronic model can then be displayed within the third coordinate system.

A second digitize operation 1810 obtains coordinates within the third coordinate system for at least three points on the patient's maxilla while the maxilla is held in the first position. The points obtained from the maxilla can be taken simultaneously or sequentially, depending on the system used to obtain the points. Typically, the first digitize operation 1808 and the second digitize operation 1810 are performed close in time to one another. To obtain meaningful data, the patient cannot move her head or her mandible and maxilla between the two digitize operations 1808, 1810. In some embodiments, the patient is restrained from moving her head or portions thereof during the two operations 1808, 1810.

A second align operation 1812 maps corresponding coordinates of the electronic model of the patient's maxilla to the obtained coordinates within the third coordinate system. The relative positioning of the electronic models, therefore, accurately depicts the positioning of the patient's mandible relative to the patient's maxilla when the mandible and maxilla are held in the first position. The alignment process 1800 ends at stop module 1814.

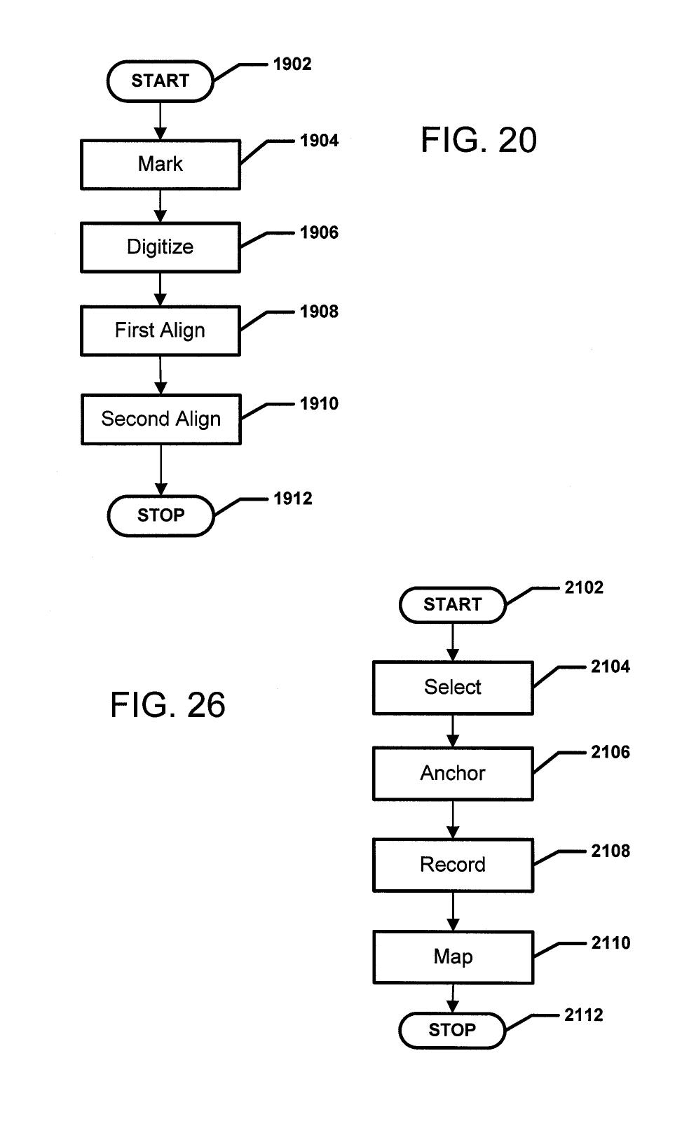

FIG. 20 illustrates an operational flow for an alternative alignment process 1900. As before, the electronic model representing the mandible has coordinates known within a first coordinate system and the electronic model representing the maxilla has coordinates known within a second coordinate system. The alignment process 1900 begins at start module 1902 and proceeds to a mark operation 1904. The mark operation 1904 indicates occlusal points on the teeth of the upper and lower arches of the patient. For example, the occlusal points can be marked using articulation paper or any other known marking techniques.

A digitize operation 1906 obtains coordinates within a third coordinate system for at least three points representing points of occlusion between the teeth on the patient's mandible and maxilla. For example, a stylus of a digitizing device can be contacted to the marked points on the patient's teeth. Because the coordinates represent points of occlusion (i.e., or contact) between the teeth of the mandible and the teeth of the maxilla, only one set of coordinates need be obtained, rather than separate coordinates from the mandible and maxilla. The obtained points can be taken simultaneously or sequentially, depending on the system used to obtain the points. Additional points can be taken to increase the accuracy of the simulation.

A first align operation 1908 maps corresponding coordinates of the electronic model of the patient's mandible to the obtained coordinates within the third coordinate system. Because at least three points were obtained, the electronic model of the mandible can be placed and oriented properly within the third coordinate system. The electronic model can then be displayed within the third coordinate system.

A second align operation 1910 maps corresponding coordinates of the electronic model of the patient's maxilla to the obtained coordinates within the third coordinate system. The relative positioning of the electronic models, therefore, accurately depicts the positioning of the patient's mandible relative to the patient's maxilla when the mandible and maxilla are held in occlusion. The alignment process 1900 ends at stop module 1912.

Referring to FIGS. 21-24, one example digitizing system 2000 that can be used to align the electronic models 101, 102 within a common coordinate system includes a digitizing device 2010 and a computing device 2040. FIG. 21 depicts the use of the example digitizing system 2000 to perform the operations of the alignment processes 1800, 1900 described above. A stylus 2020 of the digitizing device 2010 can be pressed against or contacted to points on the teeth, gums, or skin of a patient 2060 to obtain coordinates for these points within a coordinate system of the digitizer device 2010. For example, in FIG. 21, the stylus 2020 contacts a point P_{T} on a tooth on the patient's mandible.

The digitizing device 2010 is coupled to the computing device 2040 such that information obtained by the digitizing device 2010 can be transmitted to the computing device 2040 for analysis. In general, the computing device 2040 is configured to generate, edit, and display electronic models. The computing device 2040 also is configured to map the electronic models within the coordinate system of the digitizer device based on the transmitted information. In example embodiments, the computing device can be a personal computer or a server computer.

In general, the digitizing device 2010 typically includes one or more sensors 2038 that enable the device 2010 to track movement of the stylus 2020. The digitizing device 2010 also typically includes a processor 2032 and a memory 2034 to process, and optionally store movement information obtained from the sensors 2038. The device 2010 also includes a communication module 2036 configured to transmit (e.g., through cord 2013, through a wireless connection, etc.) information relating to the movement of the stylus 2020 to the computing device 2040.

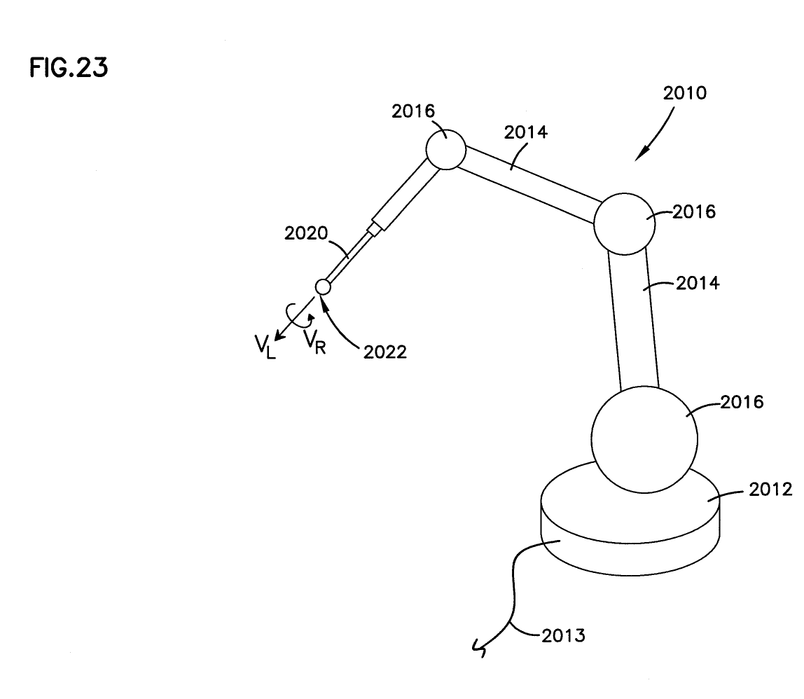

In the example shown in FIG. 23, the digitizing device 2010 includes a stylus 2020 coupled to an actuator arm 2015, which is coupled to a base 2012. The device 2010 obtains coordinate points by tracking the movement of the stylus 2020 relative to a known reference position as the stylus 2020 is moved over the surface of an object. In the example shown in FIG. 23, the stylus 2020 includes a ball-tipped stylus. In other embodiments, however, other types of styluses can be used. Some examples of other types of styluses are discussed below.

In certain embodiments, to track the movement of the stylus 2020, the device 2010 tracks the movement of the actuator arm 2015. The actuator arm 2015 includes multiple arm segments 2014 and multiple joints 2016 (FIG. 23). In some embodiments, the digitizing device 2010 tracks movement of the arm 2015 by tracking the rotational/pivotal movement of the joints 2016. Typically, the joints 2016 are ball joints or another type joints having similar degrees of movement. In other embodiments, the device 2010 tracks the movement of the arm segments 2014 over the joints 2016. Because the dimensions of the arm segments 2014 are known, coordinates for the stylus 2020 can be determined with respect to the reference position by determining the orientation of each of the arm segments 2014.

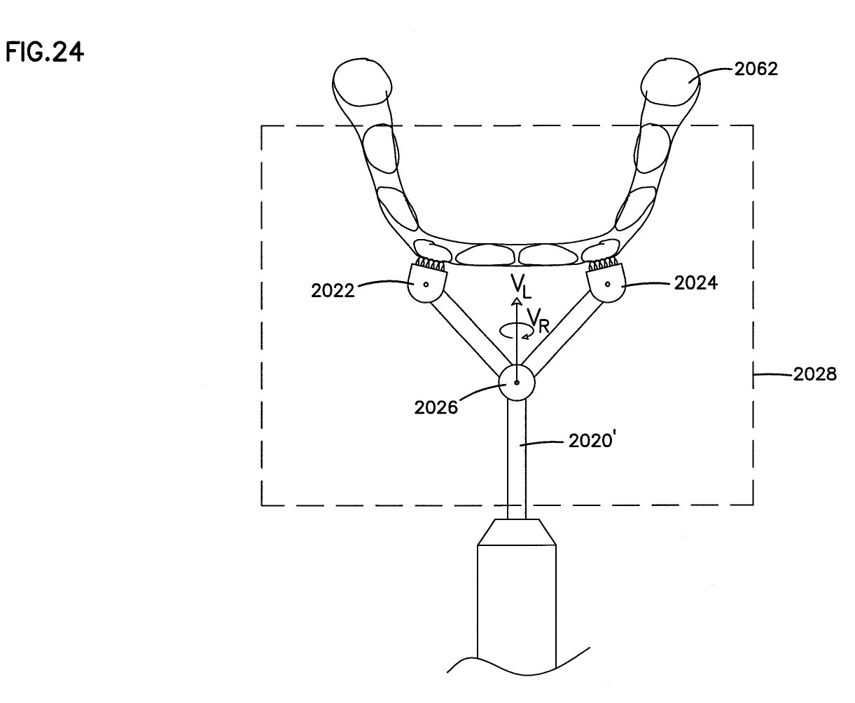

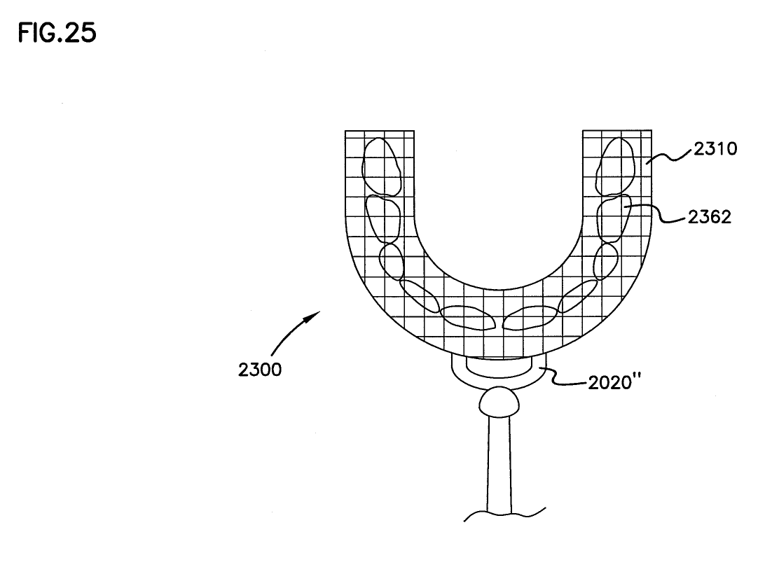

Referring to FIGS. 24 and 25, different types of styluses 2020 can be coupled to the digitizing device 2010. Some styluses 2020′ can have two or more contact tips. For example, FIG. 24 illustrates one example stylus 2020′ having a first contact tip 2022 and a second contact tip 2024. The digitizing device 2010 simultaneously tracks the movement of the first contact tip 2022 and the movement of the second contact tip 2024 relative to a reference position. The inclusion of multiple contact tips 2022, 2024 on a stylus 2020′ enables a user to obtain the coordinates of multiple points simultaneously, thereby decreasing the risk of the patient moving during the procedure and skewing the results.

FIG. 25 illustrates an example stylus 2020″ for use in an alternative digiziting system 2300. The stylus 2020″ includes a mesh 2310 formed from a piezoelectric material. The mesh 2310 is configured to generate a voltage in response to mechanical stress applied to the mesh 2310. The voltage can be measured and the measured value can be transmitted to a computing device, such as computing device 2040 (FIG. 21).

In one example embodiment, the piezoelectric mesh 2310 can be formed in the shape of an arch (see FIG. 25) to fit between the teeth 2362 of the patient's mandible and the teeth (not shown) of the patient's maxilla. When the patient bites down on the mesh 2310, a voltage is generated over the mesh 3210 adjacent the occlusal points of the patient's teeth. Because the position of multiple occlusal points can be obtained simultaneously, the patient's head need not be restrained against movement.

In one embodiment, the digitizing device 2010 is of the type manufactured by Immersion Corporation of San Jose, Calif. under the designation Microscribe Digitizer. Preferably the digitizer includes measurement of three translations and three rotations to capture measurements of six degrees of freedom.

The digitizing device 2010, however, is not limited to the above described embodiments, and other types of digitizers can be used. For example, in one alternative embodiment, a digitizer device includes one or more cameras configured to track light emitted from the stylus (e.g., light emitted from light emitting diodes mounted to the stylus). In another alternative embodiment, a digitizing device uses one or more microphones to track sound waves emitted from the stylus. In yet another embodiment, a three-dimensional camera can be used to digitize and track the position of the surface to which the camera is attached.

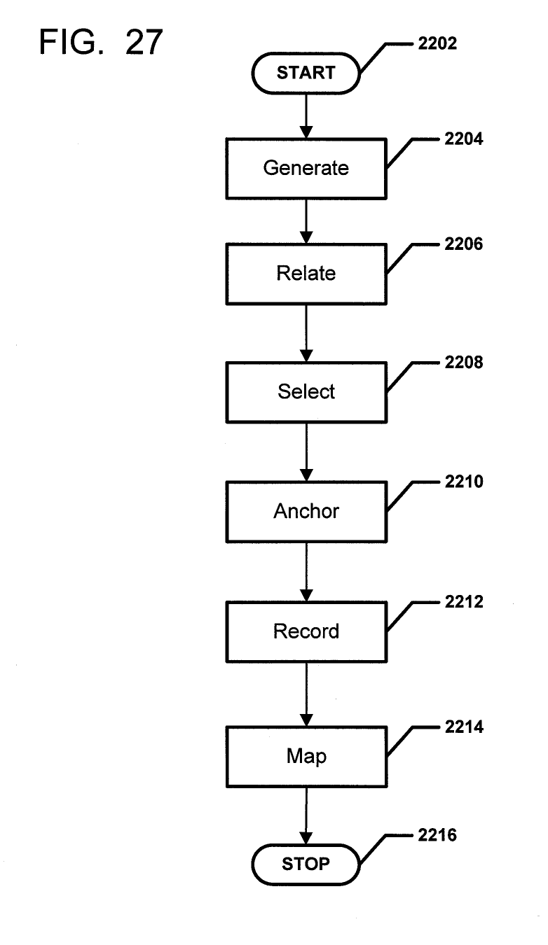

Referring now to FIGS. 26-27, the digitizing system 2000 also can be used to track natural movement of the mandible during jaw articulation. FIG. 26 illustrates an operational flow for a tracking process 2100 by which movement of a point, such as a point on the patient's mandible, can be tracked during articulation. The tracking process 2100 begins at start module 2102 and proceeds to a select operation 2104. The select operation 2104 chooses one or more points on the patient to track. For example, the select operation 2104 can decide to track the movement of a point on the patient's upper, left canine during articulation.

An anchor operation 2106 secures the stylus 2020 of the digitization device 2010 to the selected point or points. To track multiple points, a stylus 2020′ having multiple contact tips 2022, 2024, such as the stylus 2020′ shown in FIG. 24, is used.

A record operation 2108 repeatedly obtains coordinate data from the stylus 2020 during articulation of the jaw. Typically, the obtained coordinates are stored in sequence or matched with a timing value. In some embodiments, in addition to the physical location of the stylus 2020, the digitizing device 2010 also can determine a first vector V_{L} indicating the direction in which the stylus 2020 is facing relative to the known reference position and a second vector V_{R} indicating the torque of the stylus 2020 relative to the reference position (see FIG. 23).

When using the stylus 2020′ shown in FIG. 24, the record operation 2108 obtains a first set of coordinate data from the first contact tip 2022 of the stylus 2020 and a second set of coordinate data from the second contact tip 2024 of the stylus 2020. Generally, each set of coordinate data includes coordinates of the respective contact tip 2022, 2024 repeatedly taken over a predetermined period of time.

In some embodiments, the stylus 2020′ can also track a reference point 2026 on the stylus 2020′ in addition to the contact tips 2022, 2024. By tracking the movement of at least three points (e.g., the first contact tip 2022, the second contact tip 2024, and the reference point 2026), the digitizing device 2010 can track the movement of a plane 2028 (e.g., linear and/or rotational movement) defined by the points 2022, 2024, 2026. Tracking the movement of the plane 2028 enables the user to determine the rotational movement of the mandible over time as well as the translational movement.

A map operation 2110 positions the electronic model 101 of the patient's mandible within a coordinate system based on the obtained point coordinates. Typically, the electronic model 101 will have a different position within the coordinate system for each coordinate obtained from the stylus 2020. By viewing the different positions in sequence, the movement of the mandible relative to the maxilla can be simulated. The tracking process 2100 ends at stop module 2112.

Referring now to FIG. 27, the digitizing system 2000 also enables tracking of additional features not represented in the generated electronic models 101, 102. For example, the digitizing system 2000 can be used to track movement of the left and/or right condyle of the patient during jaw articulation. In other embodiments, the digitizing system 2000 can track the movement of the nose, ears, chin, or other facial landmark of the patient.

FIG. 27 illustrates an operational flow for another tracking process 2200 by which a feature not represented on an electronic model can be tracked relative to the electronic model. The tracking process 2200 begins at start module 2202 and proceeds to a generate operation 2204. The generate operation 2204 obtains one or more electronic models of the patient's dentition within a first coordinate system. In one embodiment, the generate operation 2204 obtains an electronic model representing the patient's mandible and maxilla in proper alignment using one of the above described techniques.

A relate operation 2206 then places the obtained electronic model within a second coordinate system associated with the digitizing system 2000. For example, the relate operation 2206 can select three or more points on the generated electronic model and then digitize corresponding points on the patient to orient the electronic model within the second coordinate system.

A select operation 2208 chooses at least one point on the patient that does not have a corresponding point on the generated electronic model. An anchor operation 2210 secures the stylus 2020 to the selected point and a record operation 2212 repeatedly obtains coordinate data from the stylus 2020 over a period of time.

A map operation 2214 generates a point within the second coordinate system corresponding to the selected point on the patient based on the recorded coordinate data.

Because the location of the electronic model and the location of the selected point are both known within the second coordinate system, the selected point can be mapped relative to the electronic model. The map operation 2214 also can display the change in position of the selected point over time.

While the above embodiments of the present invention describe a system, method and article of manufacture for generating an electronic model for a dental impression having a common coordinate system, one skilled in the art will recognize that the use of a particular computing architecture for a data processing system are merely example embodiments of the present invention. It is to be understood that other embodiments may be utilized and operation changes may be made without departing from the scope of the present invention as recited in the attached claims.

As such, the foregoing description of the exemplary embodiments of the invention has been presented for the purposes of illustration and description. They are not intended to be exhaustive or to limit the invention to the precise forms disclosed. Many modifications and variations are possible in light of the above teaching. It is intended that the scope of the invention be limited not with this detailed description, but rather by the claims appended hereto.

We claim:

1. A method for modeling jaw articulation, the method comprising:
generating a first model representing a mandible of a patient, the first model having coordinates, the coordinates being known within a first coordinate system;
digitizing at least three points on the mandible of the patient, wherein digitizing the points obtains coordinates for the points within a second coordinate system;
identifying coordinates of an equal number of points on the first model within the first coordinate system corresponding to the coordinates of the digitized points;
aligning the first model within the second coordinate system based on the digitized points;
generating a second model representing a maxilla of the patient, the second model having coordinates, the coordinates being known within a third coordinate system;
digitizing at least three points on the maxilla of the patient within the second coordinate system, wherein digitizing the points obtains coordinates for the points within the second coordinate system;
identifying coordinates of an equal number of points on the second model within the third coordinate system corresponding to the coordinates of the digitized points; and
aligning the second model within the second coordinate system based on the digitized points.

2. The method of claim 1, further comprising:
selecting a landmark point on the patient; and
digitizing the landmark point, wherein digitizing the landmark point obtains coordinates for the landmark point within the second coordinate system.

3. The method of claim 2, further comprising:
displaying the digitized landmark point within the second coordinate system in relation to one of: the first model, the second model, and both the first and second model.

4. The method of claim 2, further comprising:
anchoring a tracker to the landmark point on the patient; and
tracking movement of the landmark point during jaw articulation.

5. The method of claim 4, wherein tracking movement comprises:
positioning the mandible and maxilla of the patient in a first position relative to one another;
obtaining first coordinates of the landmark point;
moving the mandible and maxilla of the patient to a second position;
obtaining second coordinates of the landmark point.

6. The method of claim 5, wherein a predetermined number of coordinates of the landmark point are obtained during natural movement of the mandible and maxilla.

7. The method of claim 4, further comprising:
displaying articulation of the second model relative to the first model in the second coordinate system.

8. The method of claim 4, further comprising:
displaying articulation of the landmark point within the second coordinate system.

9. The method of claim 1, wherein the at least three points on the mandible and the at least three points on the maxilla of the patient comprise occlusal points.

10. A system for modeling jaw articulation, comprising:
means for generating a first model representing a mandible of a patient, the first model having coordinates, the coordinates being known within a first coordinate system;
means for digitizing at least three points on the mandible of the patient, wherein digitizing the points obtains coordinates for the points within a second coordinate system;
means for identifying coordinates of an equal number of points on the first model within the first coordinate system corresponding to the coordinates of the digitized points;
means for aligning the first model within the second coordinate system based on the digitized points;
means for generating a second model representing a maxilla of the patient, the second model having coordinates, the coordinates being known within a third coordinate system;
means for digitizing at least three points on the maxilla of the patient within the second coordinate system, wherein digitizing the points obtains coordinates for the points within the second coordinate system;
means for identifying coordinates of an equal number of points on the second model within the third coordinate system corresponding to the coordinates of the digitized points; and
means for aligning the second model within the second coordinate system based on the digitized points.

11. The system of claim 10, further comprising:
means for selecting a landmark point on the patient; and
means for digitizing the landmark point, wherein digitizing the landmark point obtains coordinates for the landmark point within the second coordinate system.

12. The system of claim 11, further comprising:
means for displaying the digitized landmark point within the second coordinate system in relation to the one of: the first model, the second model, and both the first and second model;
means for anchoring a tracker to the landmark point on the patient; and
means for tracking movement of the landmark point during jaw articulation.

13. A system for modeling jaw articulation, comprising:
a scanner device arranged and configured to generate a first model representing a mandible of a patient, the first model having coordinates, the coordinates being known within a first coordinate system, and a second model representing a maxilla of the patient, the second model having coordinates, the coordinates being known within a third coordinate system;
a digitizer arranged and configured to digitize at least three points on the mandible of the patient, wherein digitizing the points obtains coordinates for the points within a second coordinate system, and to digitize at least three points on the maxilla of the patient within the second coordinate system, wherein digitizing the points obtains coordinates for the points within the second coordinate system; and
a processor operatively connected to the scanner and the digitizer, the processor arranged and configured to identify coordinates of an equal number of points on the first model within the first coordinate system corresponding to the coordinates of the digitized points, align the first model within the second coordinate system based on the digitized points, identify coordinates of an equal number of points on the second model within the third coordinate system corresponding to the coordinates of the digitized points, and to align the second model within the second coordinate system based on the digitized points.

14. The system of claim 13, wherein the digitizer further digitizes a selected landmark point on the patient, whereby coordinates for the landmark point within the second coordinate system are determined.

15. The system of claim 14, further comprising: a video display unit, operatively connected to the processor, the video display unit arranged and configured to display the digitized landmark point within the second coordinate system in relation to the one of: the first model, the second model, and both the first and second model.

16. The system of claim 13, wherein the digitizer includes both rotation and translation to provide measurements for six degrees of freedom.

17. The system of claim 15, wherein the video display unit further displays articulation of the landmark point within the second coordinate system.

18. A system for modeling jaw articulation, comprising:
a scanner device arranged and configured to generate a first model representing a mandible of a patient, the first model having coordinates, the coordinates being known within a first coordinate system, and a second model representing a maxilla of the patient, the second model having coordinates, the coordinates being known within a third coordinate system;
a digitizer device including both translation and rotation measurements wherein three translations and three rotations are measured in order to capture six degrees of freedom, the digitizer capturing at least three points on the mandible of the patient, wherein capturing the points obtains coordinates for the points within a second coordinate system, and to capture at least three points on the maxilla of the patient within the second coordinate system, wherein capturing the points obtains coordinates for the points within the second coordinate system; and
a processor operatively connected to the scanner and the digitizer, the processor arranged and configured to identify coordinates of an equal number of points on the first model within the first coordinate system corresponding to the coordinates of the captured points, align the first model within the second coordinate system based on the captured points, identify coordinates of an equal number of points on the second model within the third coordinate system corresponding to the coordinates of the captured points, and to align the second model within the second coordinate system based on the captured points.

19. The system of claim 18, wherein the digitizer further captures a selected landmark point on the patient, whereby coordinates for the landmark point within the second coordinate system are determined.

20. The system of claim 14, further comprising: a video display unit, operatively connected to the processor, the video display unit arranged and configured to display the digitized landmark point within the second coordinate system in relation to the one of: the first model, the second model, and both the first and second model, and to display articulation of the landmark point within the second coordinate system.
